(19) United States
(12) Patent Application Publication
(10) Pub. No.: US 2007/0271308 A1
(43) Pub. Date: Nov. 22, 2007

(54) Methods and apparatus for managing retention of information assets

(75) Inventors: R. Mark Bentley, Acton, MA (US); L. Maurice Labrie, Milton, NH (US); C. Richard Reese, Boston, MA (US)

Correspondence Address: WOLF GREENFIELD & SACKS, P.C., 600 ATLANTIC AVENUE, BOSTON, MA, 02210-2206, US

(73) Assignee: Iron Mountain Incorporated, Boston, MA (US)

(21) Appl. No.: 11/805,157

(22) Filed: May 22, 2007

Related U.S. Application Data
(60) Provisional application No. 60/802,347, filed on May 22, 2006.

(51) Int. Cl. G06F 17/30

(52) U.S. Cl. 707/200

(57) ABSTRACT

Methods and apparatus are provided for managing the retention of information assets. In some embodiments, a system comprising an abstraction (e.g., provided as metadata) of the information assets stored in various information stores enables a user to manage the retention of the information assets. The system may, for example, provide screen interfaces which allow the user to define one or more information stores, one or more record classes into which the information assets should be categorized, and one or more schedules defining the retention of those assets. The user may execute queries to determine which information stores hold assets satisfying certain criteria.

### FIELD OF INVENTION

This invention relates to managing the retention of an organization's information assets, such as documents and other records stored in electronic and other form(s).

### BACKGROUND OF INVENTION

Organizations are increasingly required to maintain information assets for extended periods. For example, in the U.S., the Sarbanes-Oxley Act of 2002 and related securities regulations require businesses to maintain records relevant to an audit or review for seven years after the audit or review is concluded. This includes all work papers, memoranda, correspondence, communications, and other documents. For many businesses, these records represent an extremely large amount of information that must be reliably managed. As a result, many organizations have adopted document retention policies and installed retention management systems to implement those policies. In general, retention management systems assist businesses in complying with document retention policies and laws and protect against allegations of selective document destruction. Retention management systems may also ensure that valuable information assets are available to businesses when needed, such as when an organization is in litigation and is required to collect and organize assets that could serve as exhibits.

In general, conventional computer-based retention management systems assume direct access to information assets in electronic form. However, given that electronic records may be created and stored by numerous software applications (and applications may execute under different operating systems), and that records may be stored in different formats, in different file types and on various media, it has proven complex and difficult to provide conventional retention management systems with direct electronic access. This is especially true for large organizations with numerous and disparate information assets, applications and systems.

Additionally, many organizations do not store all information assets in electronic form, so that their needs are not fully addressed by conventional retention management systems. For example, many organizations maintain file rooms in which documents and other assets are kept in physical (e.g., hard copy) form. Conventional retention management systems fail to properly manage the retention and destruction of information assets in physical form.

In addition, many organizations maintain operations in more than one country or geopolitical entity, and thus may be subject to different document retention laws. For example, businesses with operations in the United States and Europe may be subject to document retention laws of the U.S., the European Union and individual European countries.

### SUMMARY OF INVENTION

Some embodiments of the present invention provide a method for managing the retention of information assets stored in a plurality of information stores, at least one information store being in communication with a software application which stores information assets in electronic form, each information asset being classifiable into one of a plurality of record classes. The method comprises acts of: (A) defining an abstraction which represents the information assets stored in the information stores, the abstraction including a representation of at least one record class in which information assets are categorized; (B) defining a retention schedule which specifies a retention event for the information assets in at least one record class; and (C) implementing the retention schedule by communicating an instruction to perform a retention event with respect to the information assets in the at least one record class.

In some embodiments, at least one computer-readable medium is provided having instructions encoded thereon which, when executed, perform a method for managing the retention of information assets stored in a plurality of information stores, at least one information store being in communication with a software application which stores information assets in electronic form, each information asset being classifiable into one of a plurality of record classes. The method comprises acts of: (A) defining an abstraction which represents the information assets stored in the information stores, the abstraction including a representation of at least one record class in which information assets are categorized; (B) defining a retention schedule which specifies a retention event for the information assets in at least one record class; (C) implementing the retention schedule by communicating an instruction to perform a retention event with respect to the information assets in the at least one record class.

In some embodiments, a system for managing the retention of information assets is provided. The system comprises: a plurality of information stores for storing the information assets, each information asset being classifiable into one of a plurality of record classes; at least one software application in communication with at least one of the information stores for storing information assets in electronic form; an abstraction definition component operable to define an abstraction representing the information assets stored in the information stores, the abstraction including a representation of at least one record class in which information assets are categorized; a retention schedule definition component operable to define a retention schedule specifying a retention event for the information assets in at least one record class; a retention schedule implementation component operable to implement the retention schedule by communicating an instruction to perform a retention event with respect to the information assets in the at least one record class.

In some embodiments, a method is provided for use in a system in which a plurality of information assets are stored in a plurality of information stores, each information asset having at least one characteristic, the at least one characteristic of each information asset being recorded in metadata. The method comprises an act of: (A) executing a query on the metadata to determine the information store(s) in which information assets having a particular characteristic are stored.

In some embodiments, at least one computer-readable medium is provided having instructions encoded thereon which, when executed in a system in which a plurality of information assets are stored in a plurality of information stores, each information asset being classifiable into one of a plurality of record classes, each record class having at least one characteristic recorded in metadata. The method comprises an act. of: (A) executing a query on the metadata to determine at least one information store in which information assets classified in at least one record class are stored.

In some embodiments, a system is provided for managing the retention of information assets. The system comprises: a plurality of information stores in which a plurality of information assets are stored, each information asset being classifiable into one of a plurality of record classes; metadata operable to record at least one characteristic for each record class; and a query component operable to execute a query on the metadata to determine at least one information store in which information assets classified in at least one record class are stored.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram depicting one example of a system architecture for managing the retention of information assets, in accordance with some embodiments of the invention;

FIG. 2 is a flowchart depicting a process for managing information assets, in accordance with some embodiments of the invention;

FIG. 3 is an entity relationship diagram depicting one example of a data structure in which data relating to information assets, information stores, and retention management may be stored, in accordance with some embodiments of the invention;

FIGS. 4A-4E show examples of screen interfaces which a user may employ to define one or more repositories in which information assets are stored, in accordance with some embodiments of the invention;

FIGS. 5A-5F show examples of screen interfaces which a user may employ to define one or more record classes in which information assets are categorized, in accordance with some embodiments of the invention;

FIG. 6 is a logical representation of an organizational structure which may define an inheritance of retention policy at different organizational levels, in accordance with some embodiments of the invention;

FIGS. 7A-7K show examples of screen interfaces which a user may employ to define one or more schedules for retaining information assets, in accordance with some embodiments of the invention;

FIG. 8 is a flowchart depicting a process for implementing a retention schedule, in accordance with some embodiments of the invention;

FIG. 9 shows an example of a screen interface for specifying a notification including instructions relating to the retention of information assets, in accordance with some embodiments of the invention;

FIG. 10 is a flowchart depicting a process for promoting compliance with instructions relating to the retention of information assets, in accordance with some embodiments of the invention;

FIG. 11 is a flowchart depicting a process whereby a user may specify that certain information assets should be retained, in accordance with some embodiments of the invention;

FIGS. 12A-12G show examples of screen interfaces which a user may employ to specify that certain information assets should be retained, in accordance with some embodiments of the invention;

FIG. 13 shows an example of a screen interface which a user may employ to determine the information stores in which certain information assets are maintained;

FIG. 14 is a flowchart depicting an exemplary method of searching for information assets stored in one or more information stores, in accordance with some embodiments of the invention;

FIG. 15 is a block diagram depicting a technique for classifying information assets, in accordance with some embodiments of the invention; and

FIG. 16 is a block diagram depicting a technique for classifying information assets, in accordance with some embodiments of the invention.

### DETAILED DESCRIPTION

Embodiments of the present invention are not limited in application to the details of construction and arrangement of components set forth in the following description or illustrated in the drawings, and are amenable to being implemented or practiced in various ways. Applying the teachings provided herein, for example, the various components identified below may be assembled into combinations other than those specifically discussed. In addition, the phraseology and terminology used herein is for the purpose of description, and should not be regarded as limiting. The use of “including,” “comprising,” or “having,” “containing,” “involving,” and variations thereof is meant to encompass the items listed and equivalents thereof, as well as additional items.

Some embodiments of the present invention provide a system which facilitates the identification of all (or substantially all) of the different types of information assets belonging to an organization, and implements a retention management policy that encompasses all of these types of assets, regardless of whether the assets are maintained in electronic or physical form and regardless of where the information assets are physically situated. Thus, an organization may implement an enterprise-wide retention policy which governs all information assets belonging to the organization. Aspects of the invention may enable an organization to more effectively mitigate the risk of non-compliance with the document retention laws and regulations of each geopolitical entity in which information assets are located, and help ensure that information assets are available when needed.

In some embodiments, the system includes an interface which allows a user to register each “information store” (including information stores employed by enterprise applications, and physical stores such as file rooms) with the system. (The term “information store” is used synonymously herein with the terms “asset repository” and “data pool.”) For example, an organization may register enterprise applications such as its accounts payable, accounts receivable, invoice production, human resources, payroll, capital expenditures, email, content management and sales proposal systems, as well as its physical record facilities (including outsourced facilities). The interface may allow the organization to identify the business purpose for information assets kept in each store, define a retention policy for each type of information asset, specify a disposition action for types of assets, monitor the progress of disposition actions, maintain a log of retention-related actions, and/or impose a “lockdown” or “retention hold” for a particular assets or asset types (e.g., when an asset is relevant to a litigation).

In some embodiments, the retention policy for a given information asset is defined at least in part by the business purpose or use of the asset. For example, in some embodiments, each type of asset is assigned to a particular record class, and retention policy is defined at the record class level. In one exemplary implementation, all records maintained by a particular enterprise application are assigned to a single record class. However, the invention is not limited in this respect, as records maintained by an enterprise application may be categorized in any number of record classes, and records in a particular record class may be accessed and/or maintained by any suitable number of enterprise applications. In this respect, an information asset may be categorized in a particular record class for any purpose.

In some embodiments, the system employs metadata defining rules, policies and practices relating to the retention of record classes. The metadata may, for example, facilitate integration with and between enterprise applications, to an extent which is customizable by the organization. For example, in some embodiments, the system may not be integrated with enterprise applications to the extent that the system issues instructions directly to the applications. Instead, the system may “sit above” the applications, and the metadata may include information that is usable to generate retention instructions which can be sent to administrators of the applications. For example, the metadata may include information identifying particular commands (e.g., scripts) that are to be executed to expunge certain records accessible to a system, and the administrator's contact information, so that a notification (e.g., sent via email) may be issued to the administrator to execute the commands to expunge the records.

In other embodiments, the system may be integrated with applications to the extent that retention instructions are issued directly to the applications. For example, the metadata may include information that allows instructions to be issued directly to an application. In this respect, metadata may include any suitable information relating to information stores, information assets and retention policies and practices, including asset and/or store characteristics, application version and/or business function, keywords used to determine assets in a store, physical location of a store, organizational name for a store, business unit which owns a store, or any other information. In this manner, the metadata may allow the system to serve as a platform for the integration of different enterprise applications, and enable an organization to choose the extent to which the integration occurs. Of course, the system may be integrated with each enterprise application to a different extent, such that for one application, retention instructions are sent to an administrator, and for another application, instructions are issued directly to the application. Embodiments of the invention may be implemented in any suitable fashion, as the invention is not limited in this respect.

In some embodiments, the system provides an interface by means of which a user may define a retention schedule for one or more record classes. For example, in some embodiments the system provides template retention schedules which a user may customize for certain record classes, applications, and/or retention policies. A template retention schedule may, for example, incorporate retention requirements required by law, and the user may customize the template to meet additional needs of the organization with respect to a record class. In some embodiments, the system enables the author of a retention schedule to publish the schedule as a draft to other members of the organization, so that the other members may review it, provide feedback and/or modify the draft schedule. Upon completion of the review process (for example, when a date set by the draft schedule author for the completion of the review process arrives), the retention schedule may be implemented.

In some embodiments, the system provides a central repository for retention policies and related data for all information stores and record classes. Information stored in the repository may be accessible to all users in an organization, facilitating consistent application of retention policy to all records, documents, data and other information assets kept by the organization, including those in enterprise applications and in physical stores.

In some embodiments, the system may interoperate with other (e.g., third-party) systems, and may function as “master” or “slave” in this interoperation. For example, in certain implementations the system may store retention schedules previously developed using a third-party system, and/or retention schedules developed using the system, such that the system acts as a “master” system by implementing retention schedules developed using various systems. Alternatively, the system may be used as a tool for developing retention schedules, and these schedules may be stored and implemented by one or more third-party systems, such that the system acts as a “slave” to the third-party systems. Embodiments of the invention may be implemented in any suitable fashion, as the invention is not limited in this respect.

In some embodiments, the system may enable users to search information stores for information assets meeting particular criteria. For example, a user may search all information stores for records categorized in a particular record class (e.g., “accounts payable records”), or records having one or more other characteristics. The system may identify all information stores that include records having the specified characteristic(s), including information stores accessible to enterprise applications, and information stores used to maintain information assets in physical form. Thus, the system may enable the user, and thus the organization, to quickly locate records meeting certain criteria. This may be useful, for example, if the organization needs to ensure that all records meeting the criteria are not destroyed, such as if the organization enters a litigation to which the considered records are relevant.

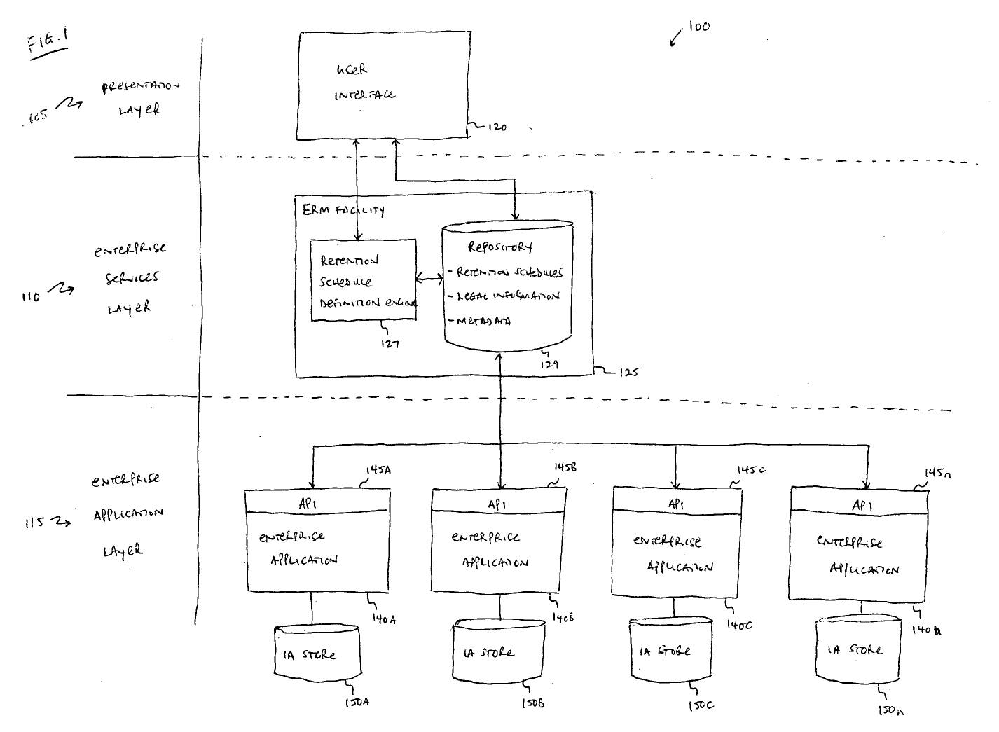

One example of a system architecture 100 enabling the implementation of consistent retention policy for information assets is shown in FIG. 1. In some embodiments, system architecture 100 includes components which reside in presentation layer 105 and enterprise services layer 110, while the various information stores maintained by an organization reside in enterprise application layer 115. Presentation layer 105 includes a user interface 120, which may be implemented, for example, as a browser-based interface which may, for example, be presented to users by a web server residing on an intranet or the internet (or both). User interface 120 may, in some implementations, enable users to configure and view retention schedules, view the record classes kept in each information store, create and execute searches, reports and queries, specify retention “holds” or “lockdowns” (i.e., create flags which will be interpreted such that certain records are not destroyed in accordance with a normal document destruction schedule), and perform various other tasks which are described in further detail below.

In some embodiments, Enterprise Retention Management (ERM) facility 125 in enterprise services layer 110 includes a retention schedule definition engine 127, which is accessed by users via user interface 120 to develop and implement retention schedules. Engine 127 includes one or more computer programs (executing on one or more processors (not shown to avoid obfuscating the presentation) which may be distributed and intercommunicate via any suitable mechanism, or reside in one or more computer systems) that may present information retrieved from repository 129 to the user, such as information on document retention laws and/or organizational retention policies which may be employed to configure a template retention schedule that the user may customize. (The not-shown computer system(s) may have the various customary components of computer systems, including one or more processors, operating systems, input/output devices such as keyboards, mice, displays, network interface cards, disk drives, semiconductor memory. etc. For example, user interface 120 may take advantage of the various input/output devices to display information on a screen and accept input via a conventional graphical user interface, voice input menu, etc.) Repository 129 may additionally store previously-developed retention schedules, as well as metadata defining business rules relating to the retention of information assets.

Information stores maintained by an organization are represented in enterprise application layer 115 at 150A-150n. Although only four enterprise applications 140A-140n are shown, any suitable number of enterprise applications may be managed according to aspects of the invention described herein, as the invention is not limited to any particular implementation. Each of applications 140A-140n may include a respective application programming interface (API) 145A-145n which enables integration with ERM 125. Specifically, metadata stored in repository 129 defines business rules, disposition actions and other information related to the retention of information assets maintained by each enterprise application. Depending on the extent to which ERM facility 125 and a particular enterprise application 140 (e.g., 140A) are integrated, ERM facility 125 may issue instructions directly to the enterprise application, issue instructions to an administrator of the enterprise application, or issue instructions in some other fashion. Once instructed (by ERM facility 125, an administrator or another means), a respective information asset store (e.g., 150A) in which information assets are maintained is accessed to carry out the instruction. For example, upon being instructed to expunge a particular set of records, a script may be executed on information asset store 150A to delete records specified by the instructions.

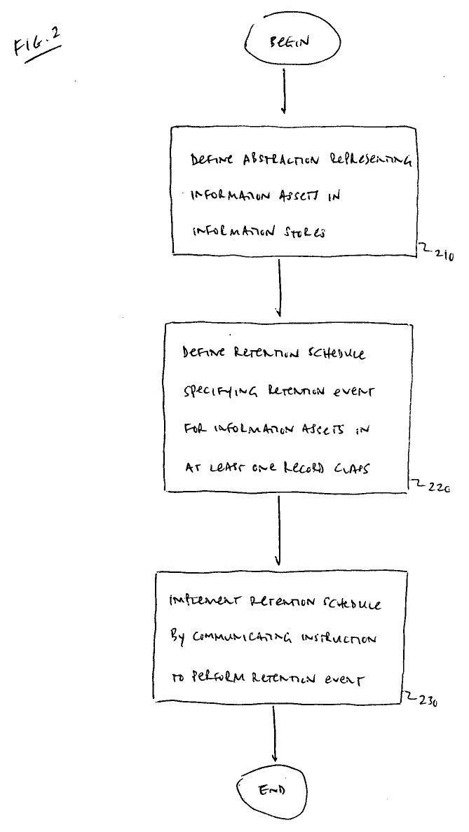

In some embodiments, system 100 may be configured to implement consistent retention policies for information assets in accordance with process 200, shown in FIG. 2. Process 200 may be performed to manage the retention of information assets which are classifiable into a plurality of record classes, and which are stored in a plurality of information stores (e.g., information asset stores 150A-150D), including at least one information store which is in communication with a software application (e.g., enterprise applications 145A-145D).

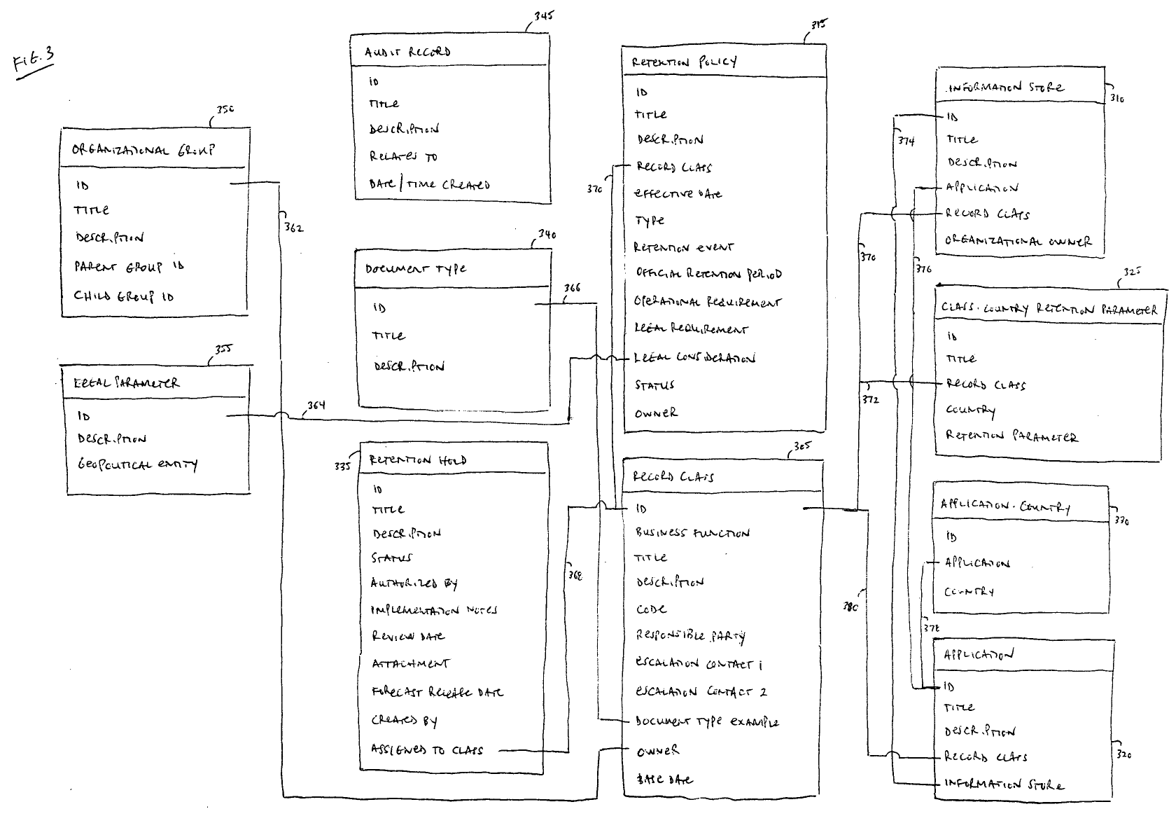

At the start of process 200, in act 210, an abstraction is defined representing information assets stored in a plurality of information stores. As described above, in one embodiment, such an abstraction comprises metadata (e.g., stored in repository 129) that includes representations of a plurality of record classes into which the information assets are organized. One example of metadata including these representations is described below with reference to FIG. 3, which depicts a data structure organized in relational form. It should be appreciated, however, that an abstraction need not be defined via metadata, and that a relational data structure need not be employed. The invention is not limited to any particular implementation.

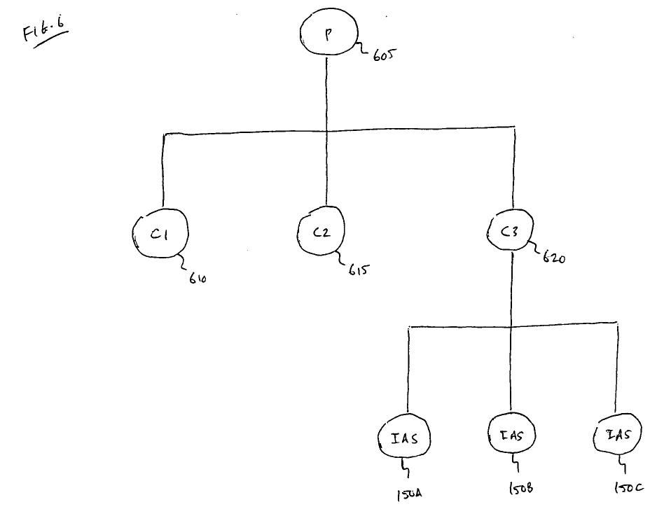

At the completion of act 210, process 200 proceeds to act 220, wherein a retention schedule is defined that specifies a retention event (e.g., disposal, hold, etc.) for information assets in one or more record classes. The definition of a retention schedule is described below in detail with reference to FIGS. 6A-6K, which depict screen interfaces which allow a user to provide input defining a retention schedule. User input may, in some embodiments, be used to populate the data structure of FIG. 3. However, it should be appreciated that a retention schedule may be defined using any suitable technique(s) and/or tool(s), and that the invention is not limited to any particular implementation.

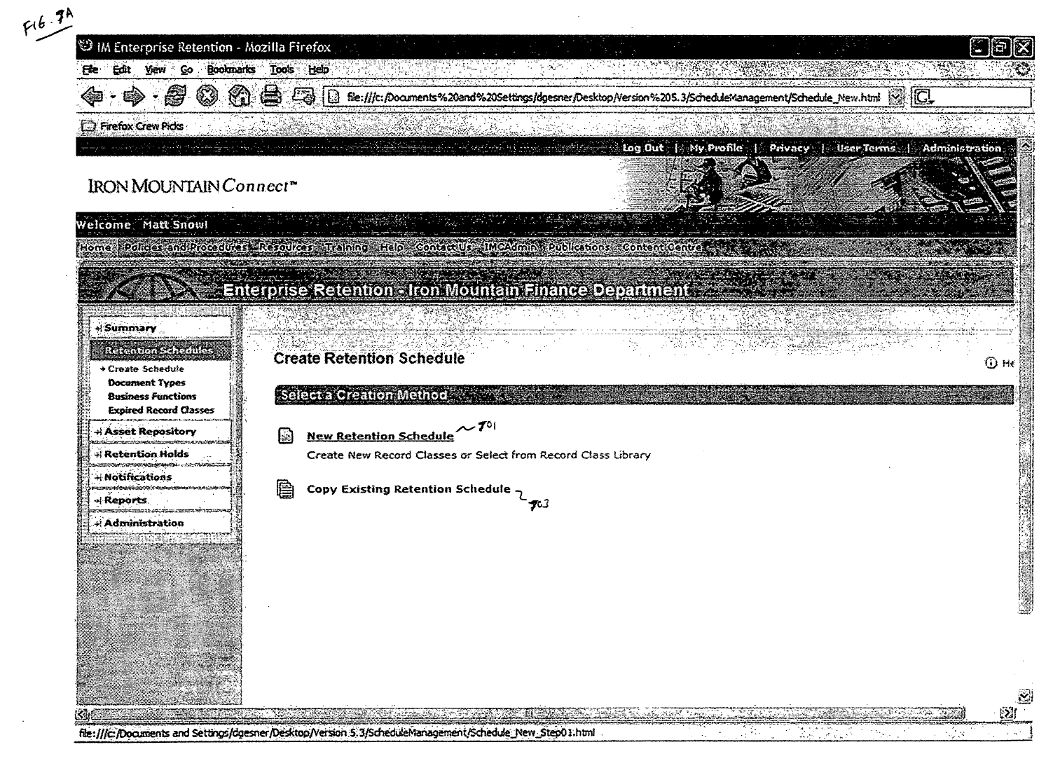

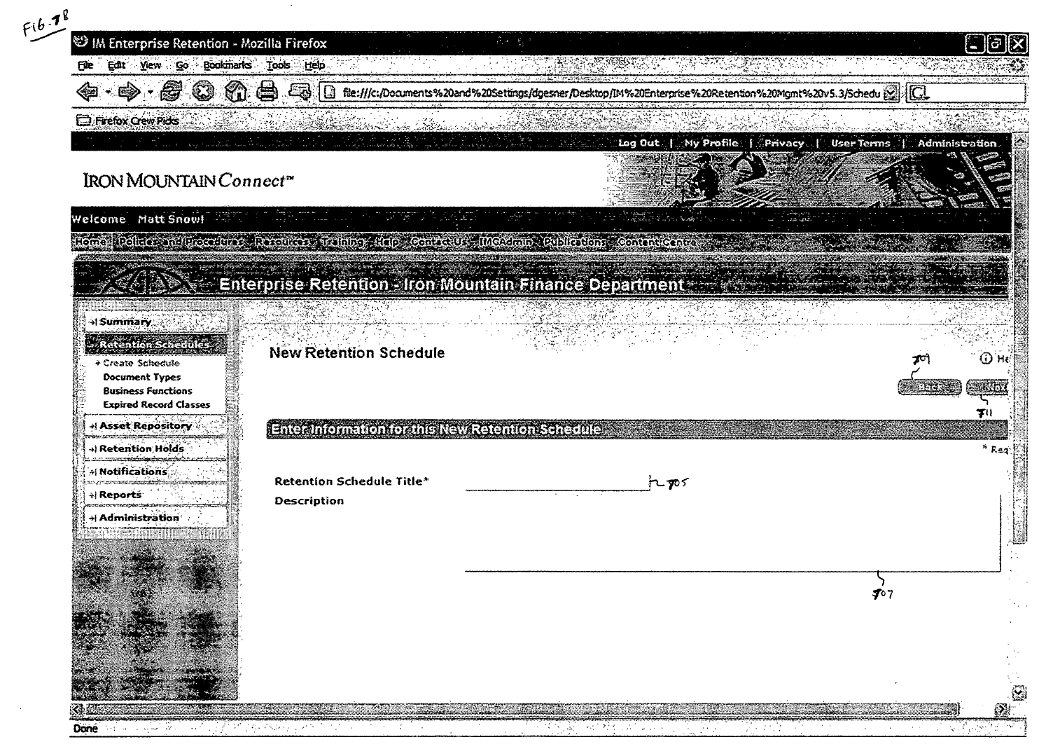

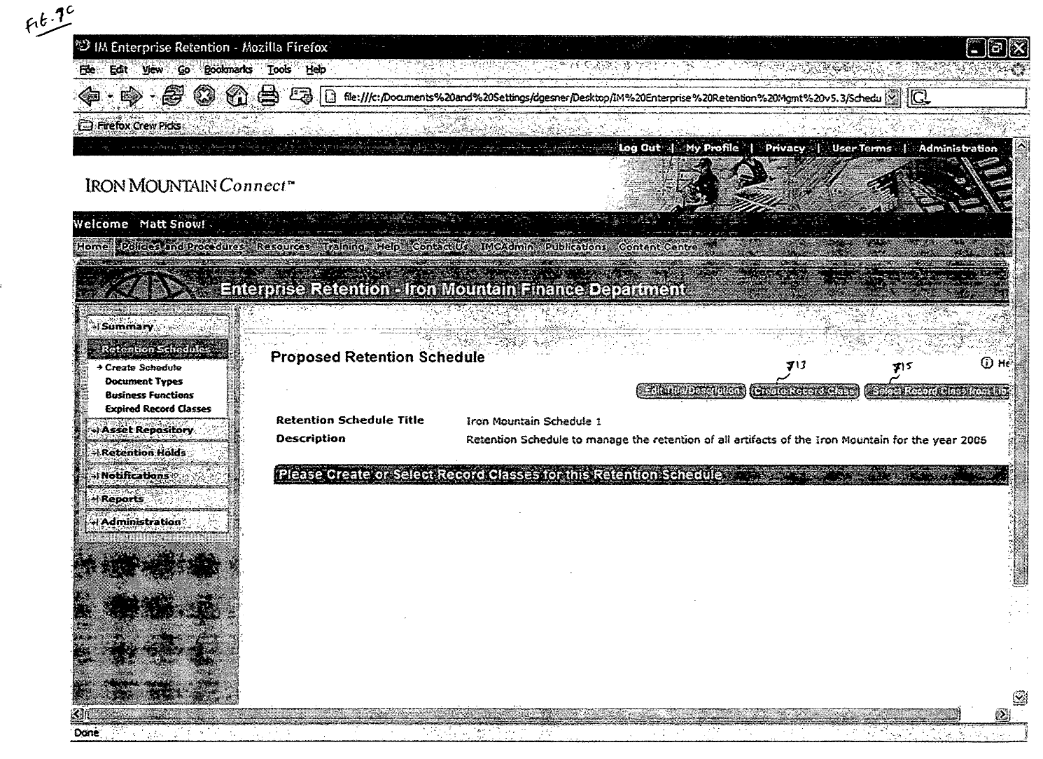

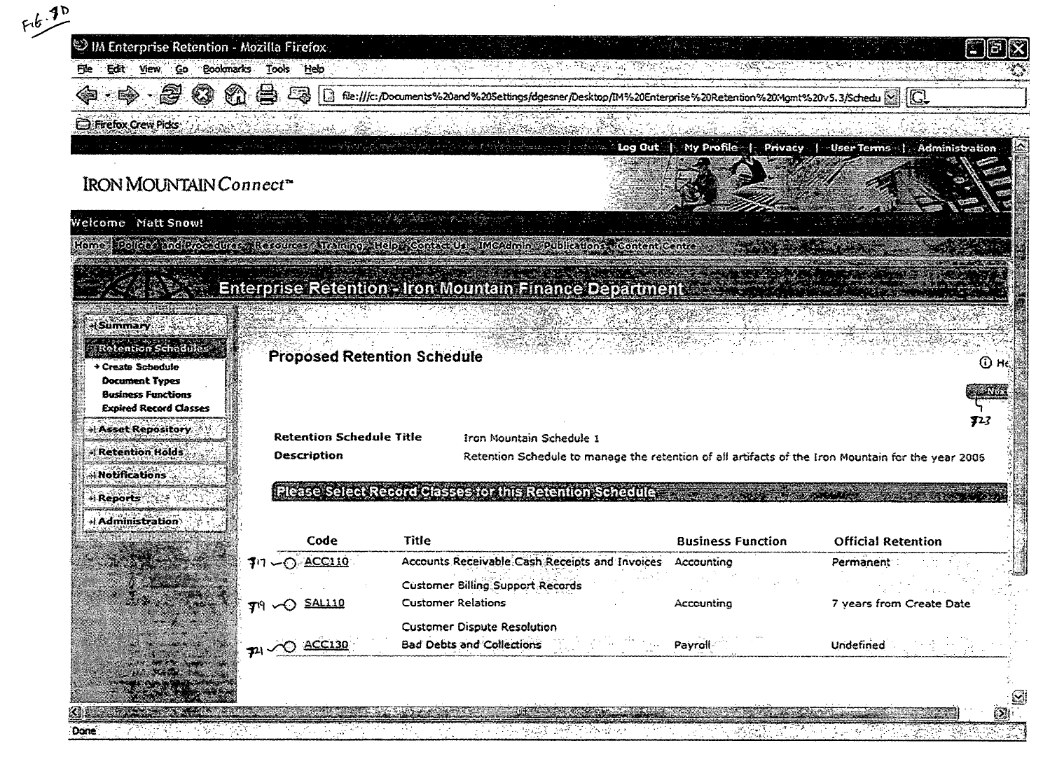

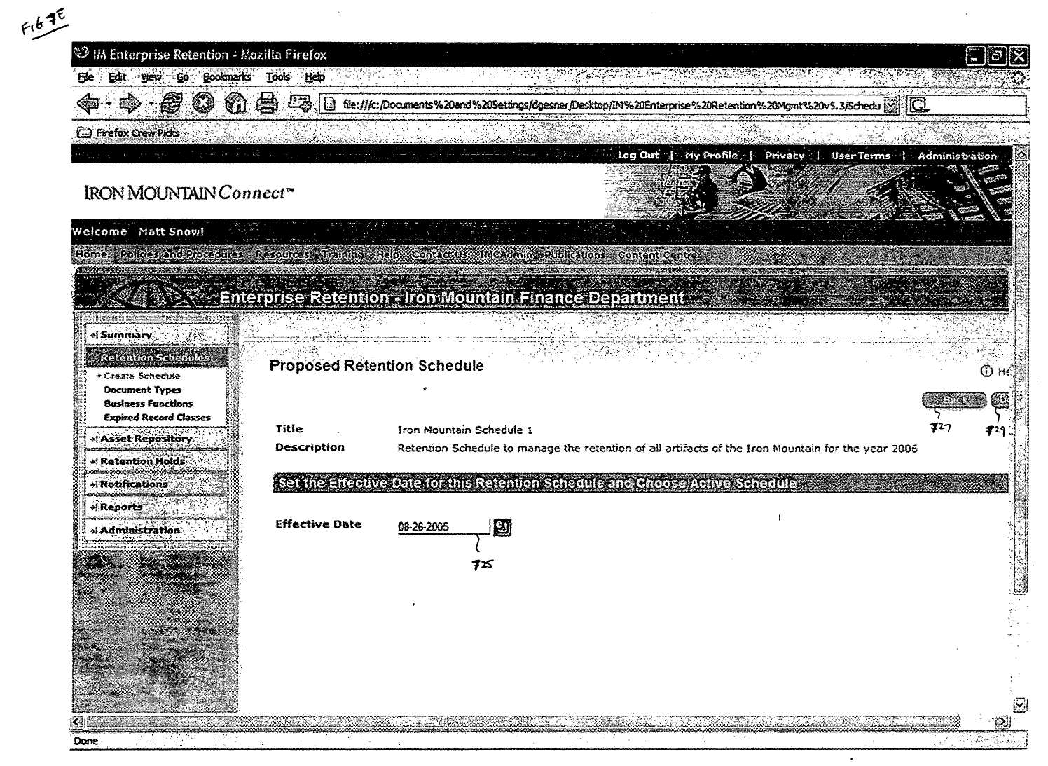

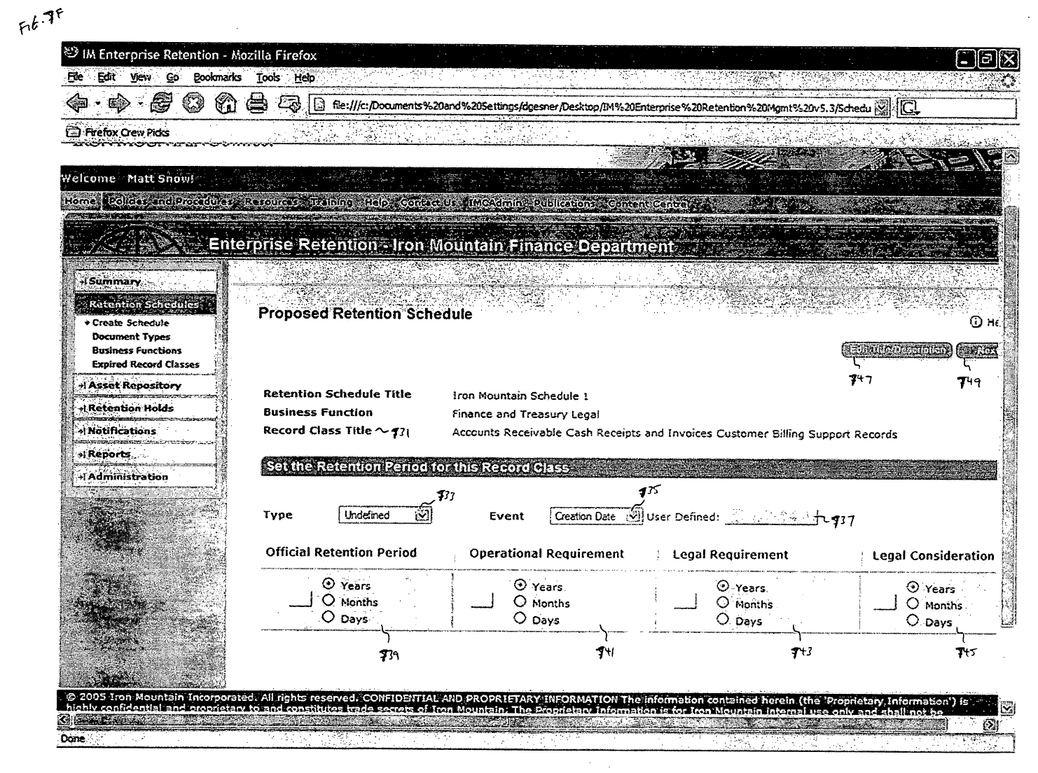

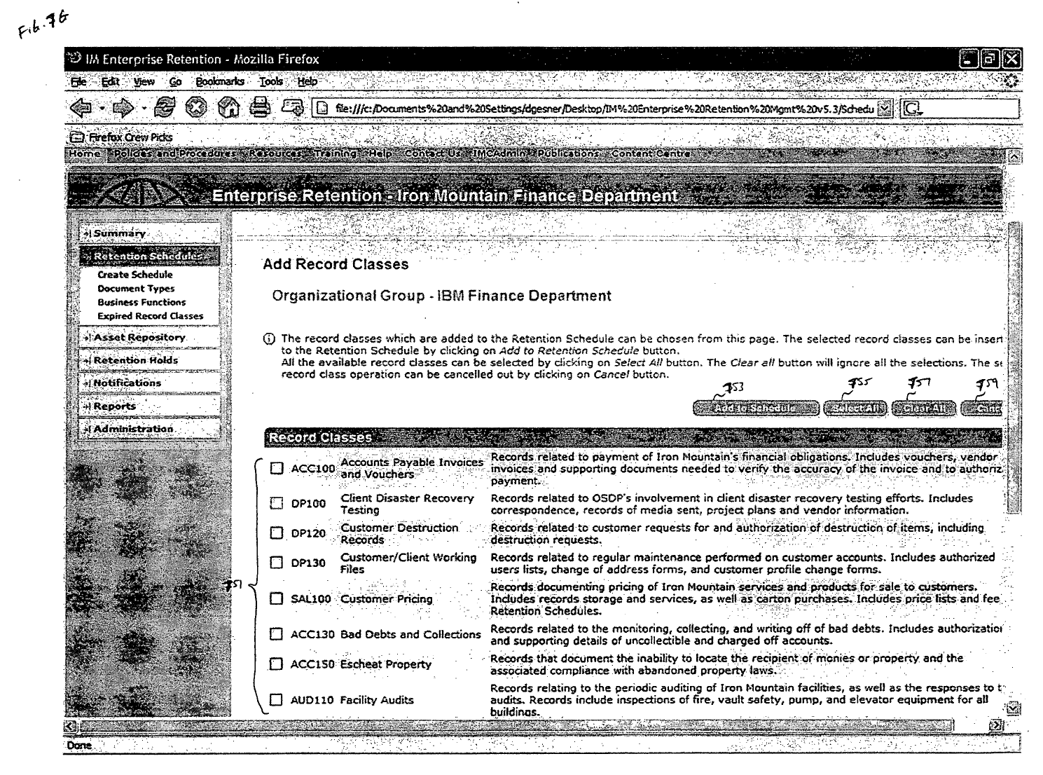

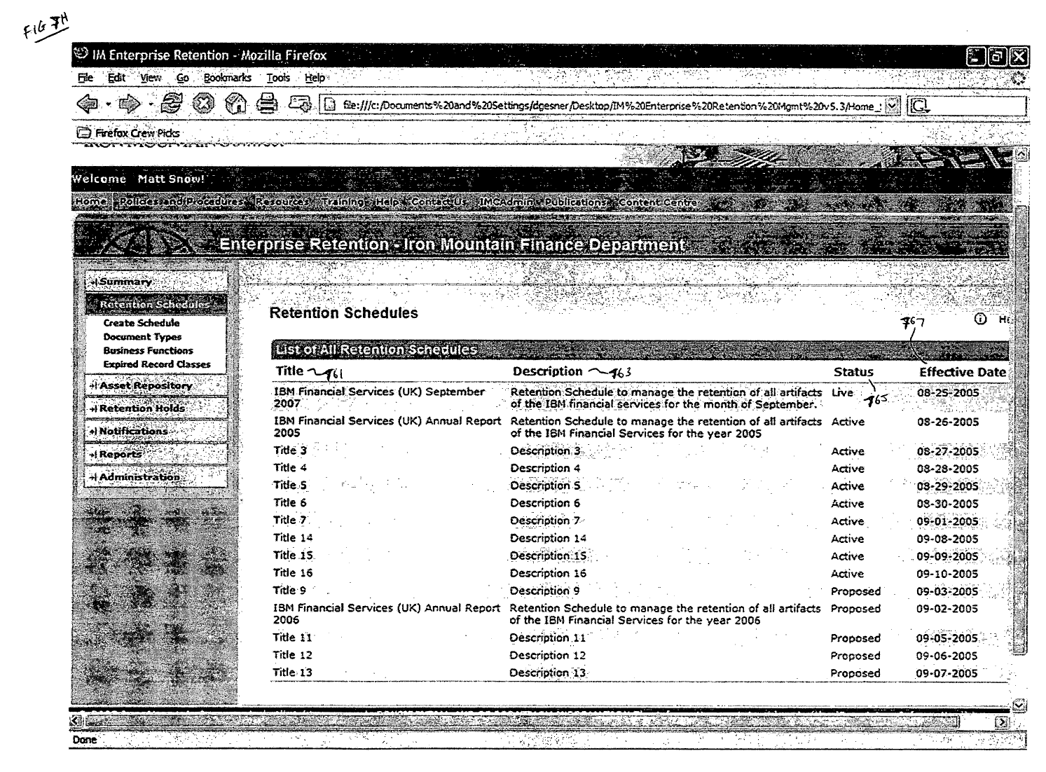

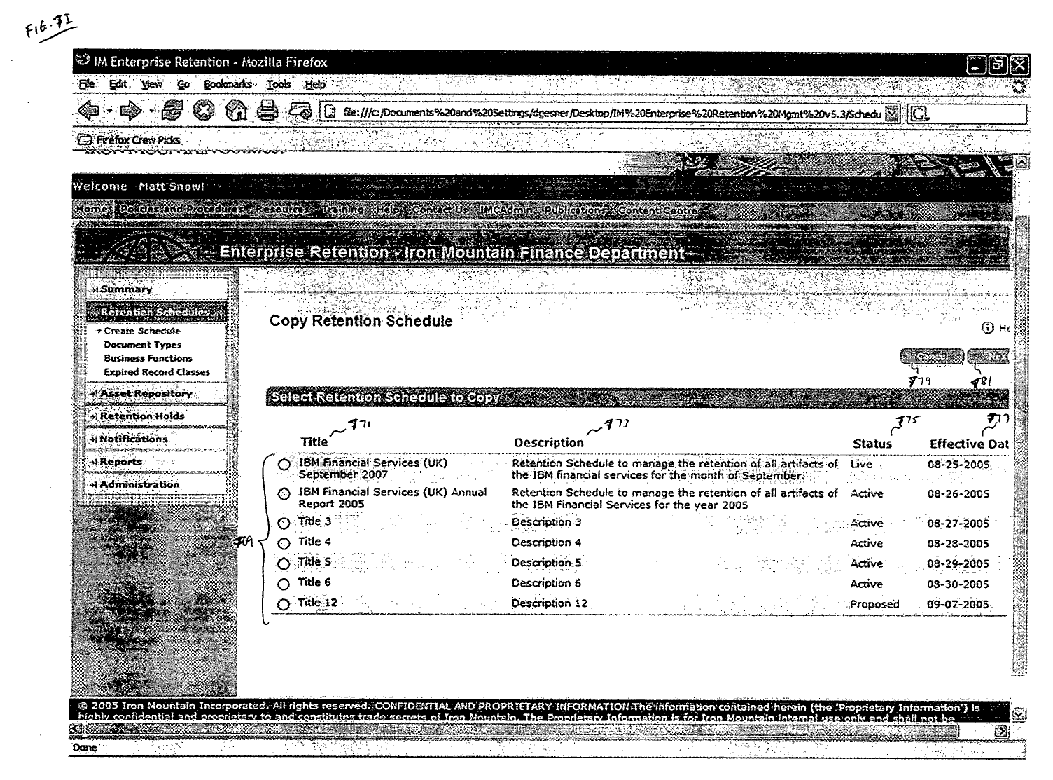

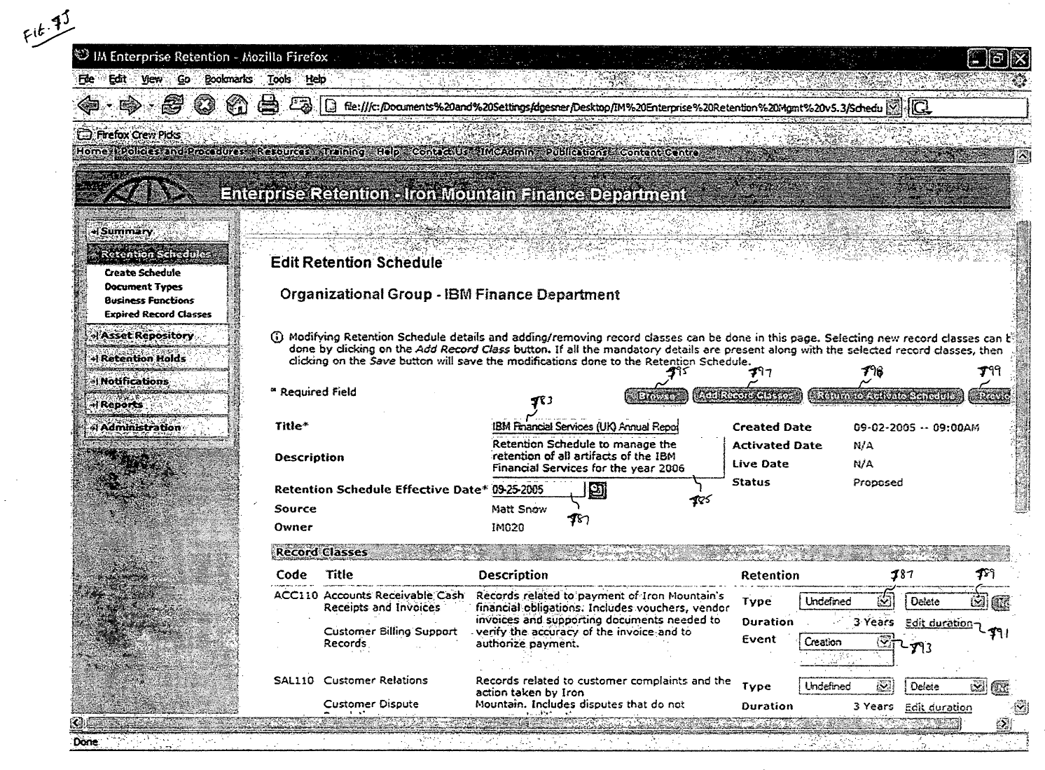

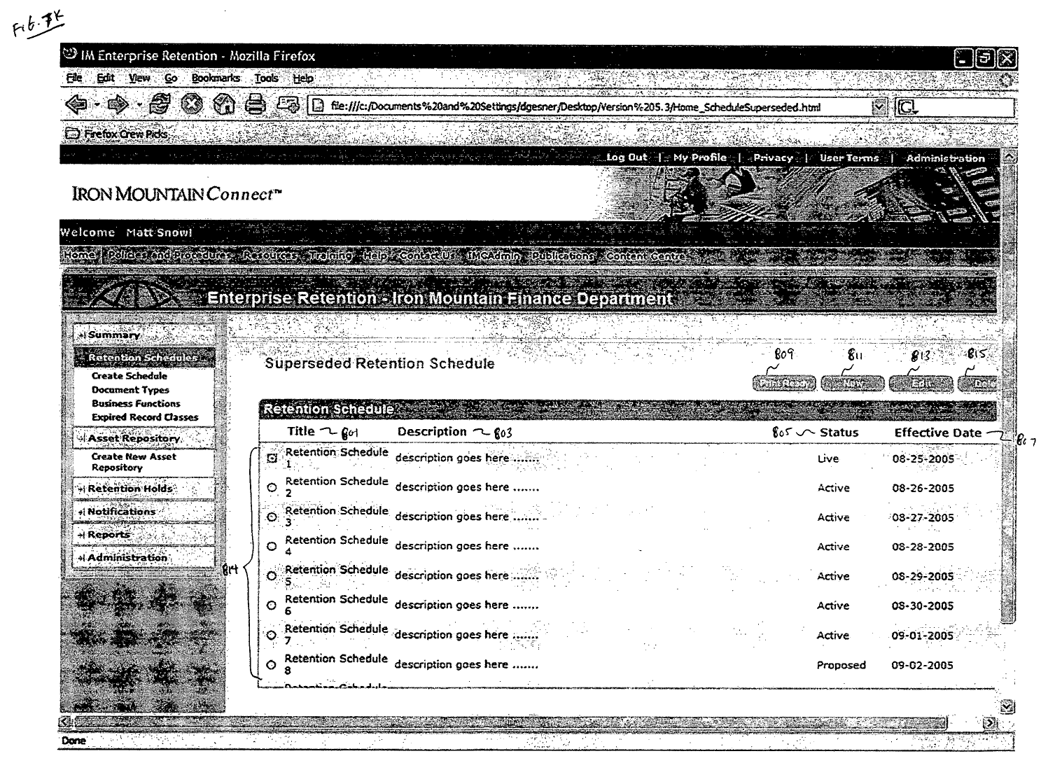

The process then proceeds to act 230, wherein the retention schedule defined in act 220 is implemented. In some embodiments, implementation of the retention schedule is effected by communicating instructions to perform one or more retention events with respect to information assets in the considered record class(es). One example of a process for implementing a retention schedule is described below with reference to FIG. 7, and involves periodically examining data relating to record classes, retention schedules and retention holds (e.g., stored in the data structure of FIG. 3) to determine whether information assets in any record class should be destroyed or expunged. Based on this determination, instructions may be sent to (e.g., emailed to an administrator of) an information store in which the considered information assets are maintained so that the instructions may be carried out. The invention is not limited to such an implementation, however, as a retention schedule may be implemented in any suitable fashion.

Upon the completion of act 230, process 200 completes.

FIG. 3 shows a simplified version of an exemplary data structure in which metadata may be stored in repository 129. The simplified data structure shown is a relational data structure which includes tables storing information related to various record classes, retention schedules, information stores, and enterprise applications. Those skilled in the art will understand that fields stored in the tables may be related via keys or other mechanism to maintain relational integrity between the fields. It should be appreciated that any of numerous non-relational data structures may alternatively be employed to store metadata, and that a data structure may include different tables, or no tables at all if a relational database is not employed.

The simplified data structure example shown includes record class table 305, information store table 310, retention policy table 315, application table 320, class-country retention parameter table 325, application-country table 330, retention hold table 335, document type table 340, audit record table 345, organizational group table 350 and legal parameter table 355. Each of these tables includes fields which are described below.

Record class table 305 stores information relating to record classes. As described above, record classes are employed to categorize information assets according to business purpose and/or use, so that the retention of the information assets may be managed in a consistent manner, such as to satisfy legal and/or business requirements. The fields stored in this table may include, for example, a record class identifier, business function, title, description, code, responsible party, document type example and status. The document type example field in this table is related via foreign key 366 to the document type identifier stored in document type table 340.

Information store table 310 stores information relating to information stores in which information assets are maintained. The fields stored in this table may include, for example, data pool identifier, title, description, enterprise application and record class. The record class field in this table is related via foreign key 370 to the record class identifier stored in record class table 305, and the enterprise application field in this table is related via foreign key 376 to the application identifier stored in application table 320.

Retention policy table 315 stores information relating to retention policies established for record classes, such that the retention of one or more record classes may be managed as a logical unit. The fields stored in this table may include retention policy identifier, title, description, record class, effective date, type, event, official retention period, operational requirement, legal requirement, legal consideration, status and owner. The record class field in this table is related via foreign key 370 to the record class identifier table stored in record class table 305.

Application table 320 stores information relating to enterprise applications that access information assets employed by the organization (e.g., in the information stores indicated in data pool registry table 310). The fields in this table may include application identifier, title, description, record class and information store. The record class field in this table is related via foreign key 380 to the record class identifier stored in record class table 305, and the information store field is related via foreign key 374 to the data pool identifier field stored in data pool registry table 310.

Class-country retention parameter table 325 stores information relating to retention rules imposed on various record classes. The fields in this table may include an identifier, title, description, record class, country, and retention parameter. The record class field in this table is related via foreign key 372 to the record class identifier stored in record class table 305.

Application-country table 330 stores a cross-reference between enterprise applications and the geopolitical entities in which information assets maintained by the enterprise applications are stored. The fields in this table may include an identifier, application, and country. The application field in this table is related via foreign key 378 to the application identifier stored in enterprise application table 320.

Retention hold table 335 stores information relating to holds placed on certain information assets that are needed by the organization, so that the information is not inadvertently destroyed. For example, a retention hold may be placed on information assets needed for an ongoing litigation. The fields stored in this table may include a retention hold identifier, title, description, status, authorizing party, implementation notes, review date, attachment, forecast release date, creating party, and assigned to (record) class. The assigned to class field in this table is related via foreign key 368 to the record class identifier stored in record class table 305.

Document type table 340 stores information relating to the different document types that may constitute a record class. The fields stored in this table may include a document type identifier, title and description. The document type field stored in record class table 305 is related via foreign key 366 to the document type identifier stored in document type table 340.

Audit record table 345 stores information on operations performed on information in data structure 300. For example, audit record table 345 may store information on retention policies created, retention holds applied, confirmations received indicating that disposal instructions have been carried out, and/or other information. The fields stored in this table may include an identifier, title, description, relates to, and date/time of record creation.

Organizational group table 350 stores information relating to the structure of the organization which applies retention policy via the system. For example, organizational table 350 may store information relating to an organizational hierarchy comprising groups at different organizational levels, such that retention policy may be applied in an effective manner at each level. Fields stored in this table may include an identifier, title, description, parent group identifier and child group identifier.

Legal parameter table 355 stores information relating to laws and/or regulations affecting retention policy. The fields stored in this table may include one or more of an identifier, description, and geopolitical entity indicator. The identifier stored in this table is related via foreign key 364 to the legal consideration field stored in retention policy table 315.

The data stored in tables 305-355 supports functionality provided by the system. Screen interfaces provided by user interface 120 (FIG. 1) allow users to interact with the system to define one or more information stores, record classes, retention schedules, retention holds, notifications, and to perform searches for particular types of information assets. A series of exemplary screen interfaces is described in the sections that follow. These screen interfaces are used to receive input to populate tables 305-340.

Defining an Asset Repository

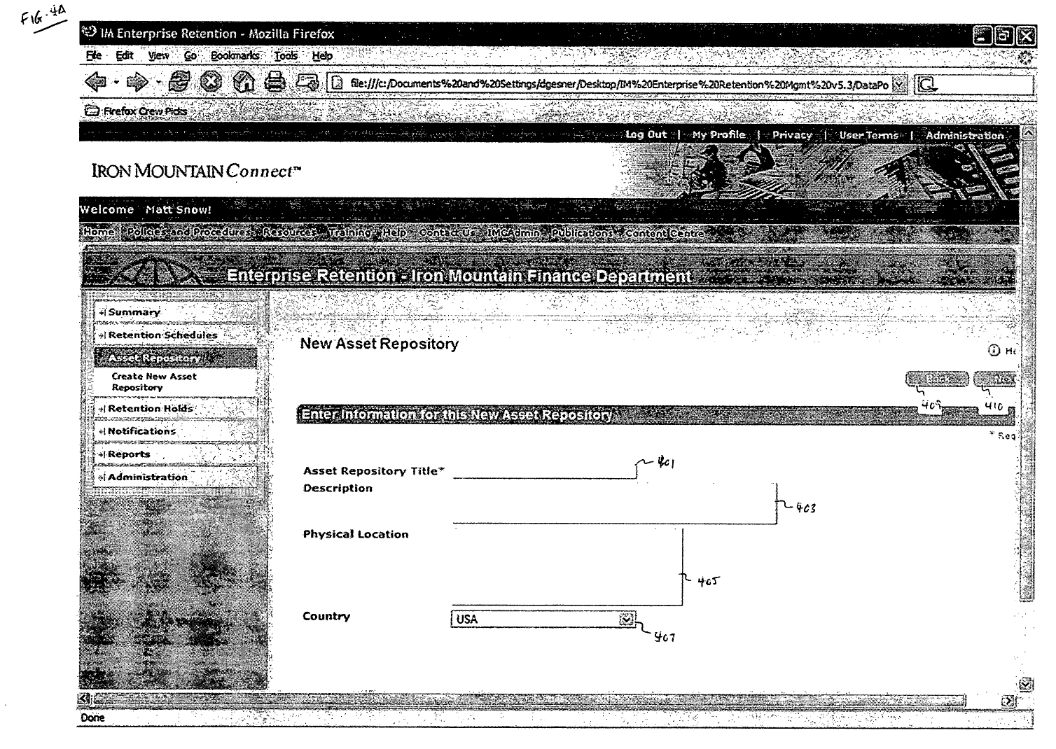

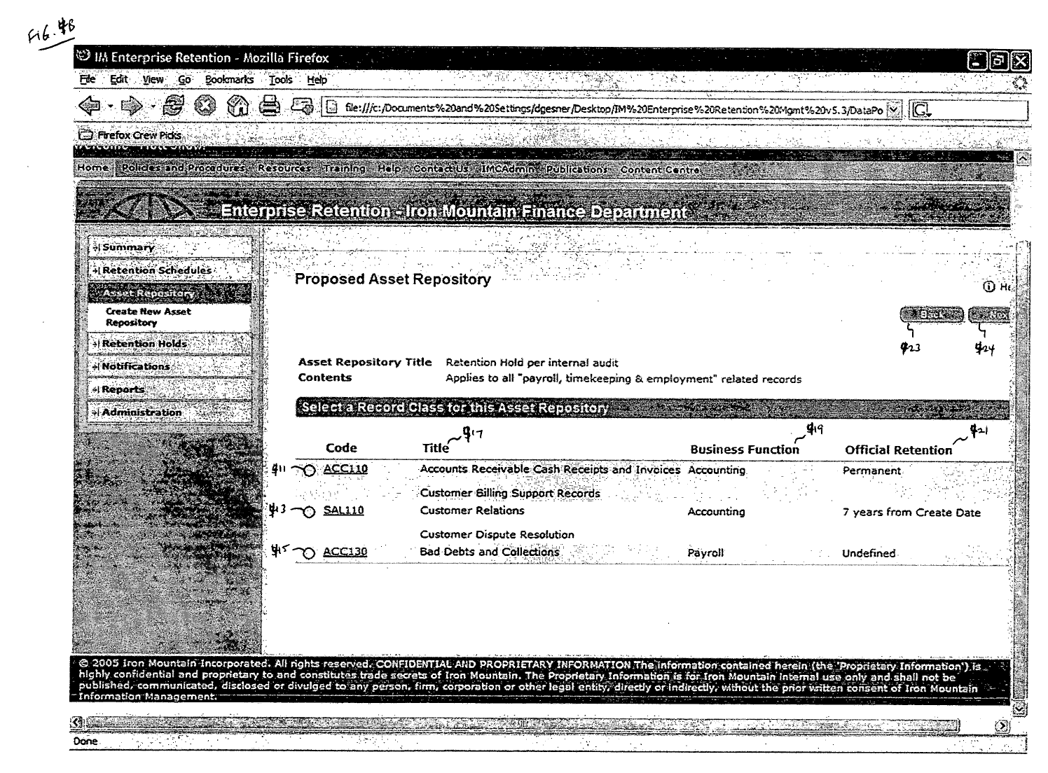

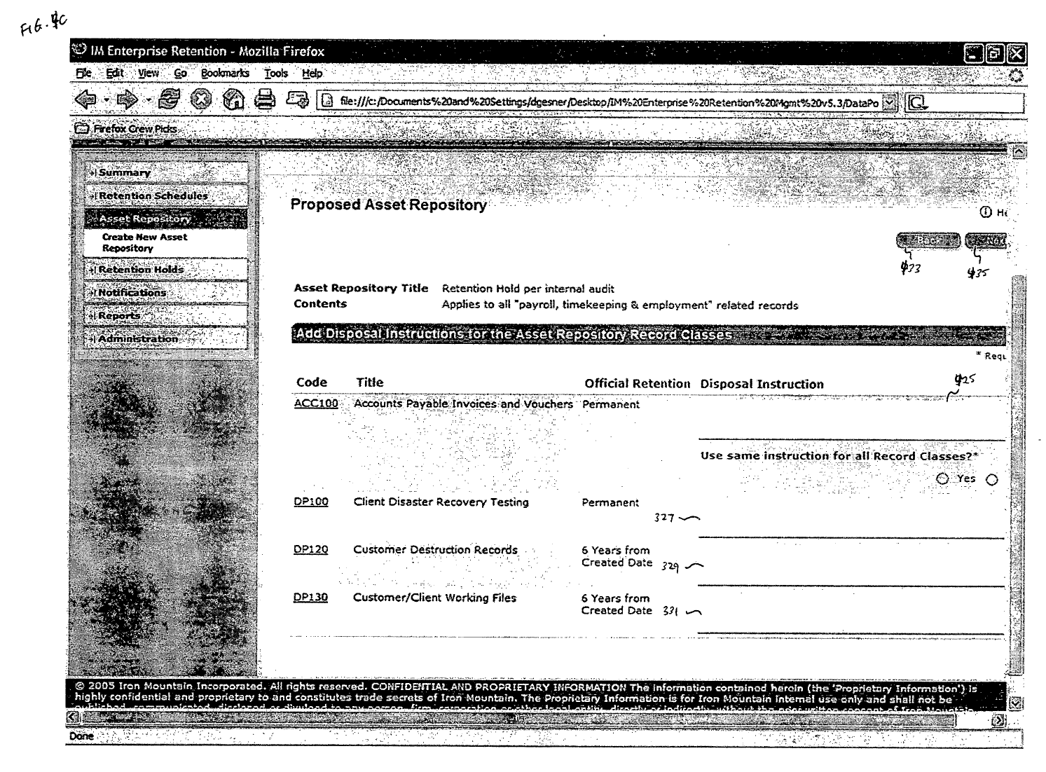

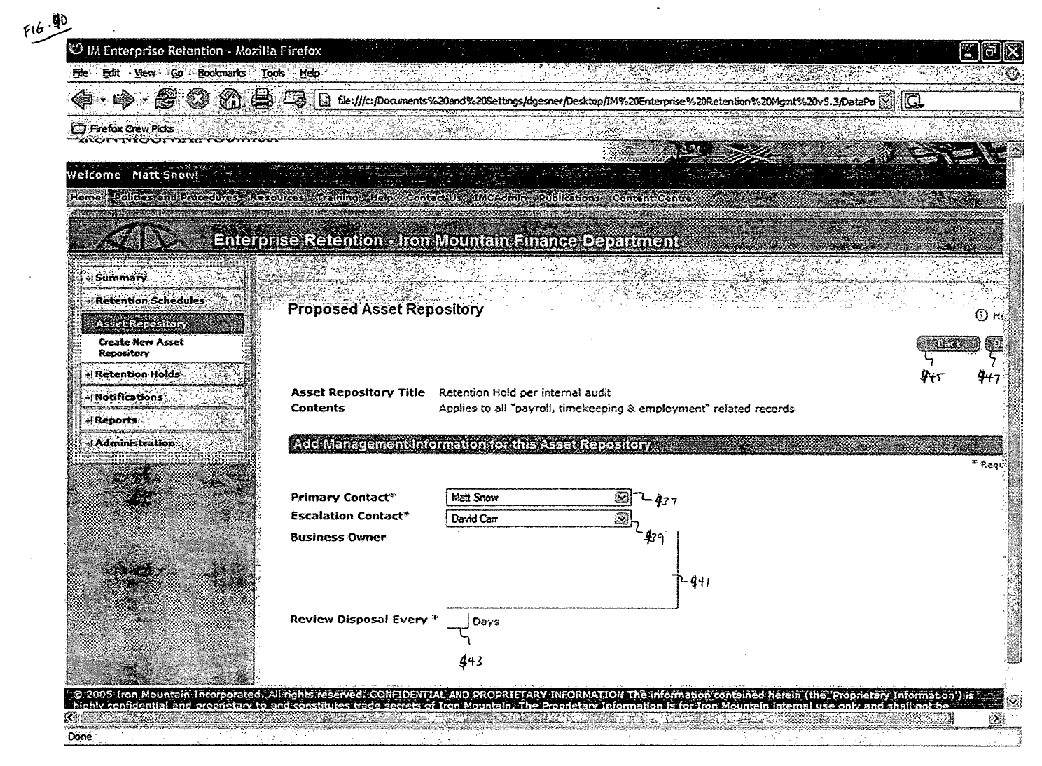

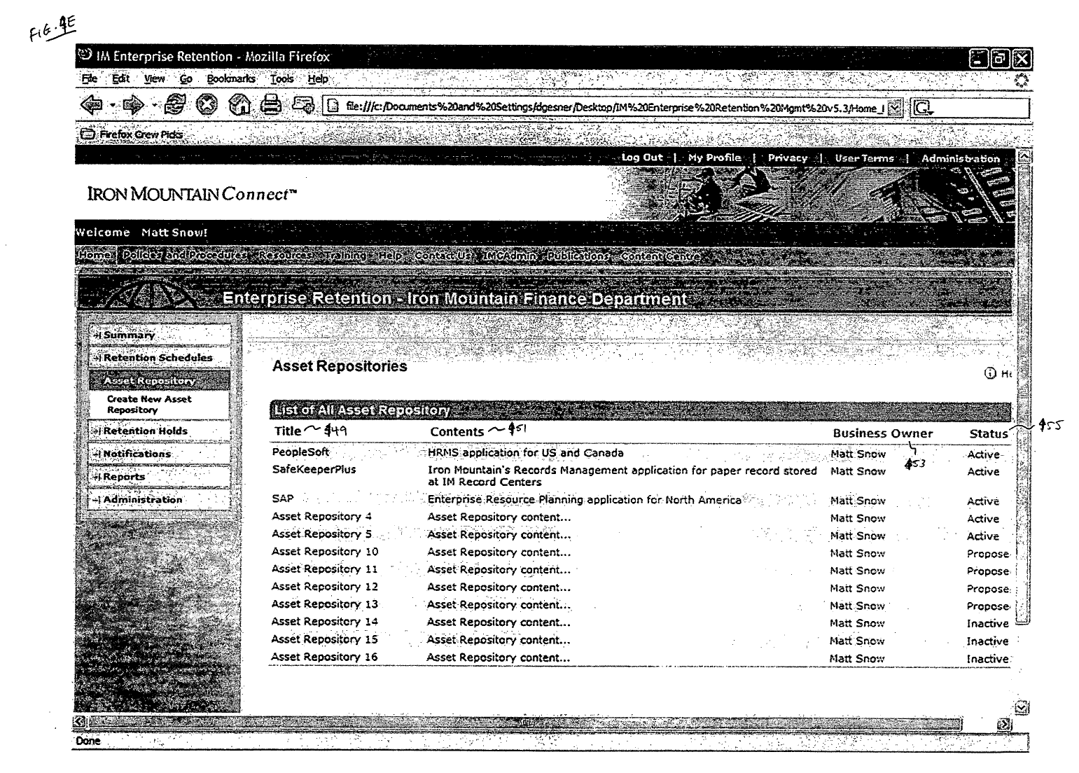

FIGS. 4A-4E depict exemplary screen interfaces which may be employed by a user of the system to define an example information store (“asset repository”). The information provided via these screen interfaces may be stored in, inter alia, information store table 310 (FIG. 3).

The screen interface depicted in FIG. 4A, which in the particular embodiment shown is presented by a browser application, includes portions which allow the user to provide information relating to the asset repository. (As is known in the art, the screen interface may accept user input in various forms, including text entry (e.g., via a keyboard), selection of options (e.g., via a mouse), and/or user input in other forms.) In field 401, the user provides a title for the asset repository; in field 403, a description; and in field 405, a physical location for the asset repository. Using dropdown box 407, the user may select the country in which the repository is located. Upon providing information in any or all of fields 401-405 and dropdown box 407, the user may click on button 410 (“next”) to record the input and proceed to a next screen interface, shown in FIG. 4B.

The screen interface depicted in FIG. 4B allows the user to select one or more record classes for information assets stored in the asset repository. Specifically, by clicking on any or all of buttons 411, 413 and 415 the user may specify that the asset repository stores information assets categorized in any of record classes “ACC 110,” “SAL 110,” and “ACC 130.” Information shown in columns 417, 419 and 421 displays characteristics of these record classes. Specifically, column 417 displays a title for each record class, column 419 displays a business function or role and column 421 displays an identification of official retention policy for information assets in the considered record class. For example, record class “ACC 110” is titled “Accounts Receivable Cash Receipts And Invoices,” has a business function of “Accounting,” and an official retention period of “Permanent.” After specifying the record class for information assets stored in the asset repository, the user may click button 424 to record the specification and proceed to a next screen interface, shown in FIG. 4C, or button 423 to revert to the screen interface shown in FIG. 4A.

The screen interface depicted in FIG. 4C allows the user to specify disposal instructions for each record class specified using the screen interface of FIG. 4B. Specifically, the screen interface of FIG. 4C indicates in the “Code” column that the user had specified four record classes (“ACC 100,” “DP 100,” “DP 120,” and “DP 130”) for information assets stored in the asset repository. By providing information in any of fields 425, 427, 429 and 431, the user may specify disposal instructions for records in each respective record class. For example, by specifying information in field 425, the user may provide disposal instructions for information assets categorized in the “ACC 100” record class. Upon providing this information, the user may click on button 435 to record the data entry and proceed to the screen interface shown in FIG. 4D, or click button 433 to revert to the screen interface shown in FIG. 4B.

The screen interface shown in FIG. 4D allows the user to specify personnel responsible for executing disposal instructions for particular record classes specified on the screen interface of FIG. 4C. Specifically, using dropdown box 437, the user may specify a primary contact to which disposal instructions may be sent. Dropdown box 437 may, for example, display a list of administrators for asset repositories recognized by the system. Using dropdown box 439, the user may select from a list of escalation contacts for the considered asset repository. The escalation contact may, for example, serve as a backup contact in case attempts to send retention instructions to the primary contact are unsuccessful, or the primary contact is unresponsive to these instructions. The escalation contact may be a person to whom the retention instructions are sent if the primary contact is unresponsive for a predetermined period of time after retention instructions are sent. Using box 441, the user may specify a business owner or the asset repository, which may comprise a specific individual or a department or division within the enterprise which is responsible for information assets stored in the repository. Using box 443, the user may specify how frequently retention instructions are sent to the primary contact for execution. By clicking button 447, the user may store the input data and proceed to the screen interface shown in FIG. 4E, and by clicking button 445 the user may revert to the screen interface shown in FIG. 4C.

The screen interface shown in FIG. 4E depicts a listing of asset repositories that are defined, or “registered,” to the system. Information relating to each asset repository is shown in columns 449 (“Title”), 451 (“Contents”), 453 (“Business Owner”), and 455 (“Status”). Thus, the screen interface shown in FIG. 4E displays a roster of asset repositories registered to the system, and information on each.

Defining a Retention Schedule

A retention schedule may be defined for information assets organized in one or more record classes. As described above, a record class is a group of records which are placed in a same retention category by virtue of having a common business use and/or purpose. As such, defining a retention schedule for a record class ensures that records having a common business use or purpose are managed in a consistent manner.

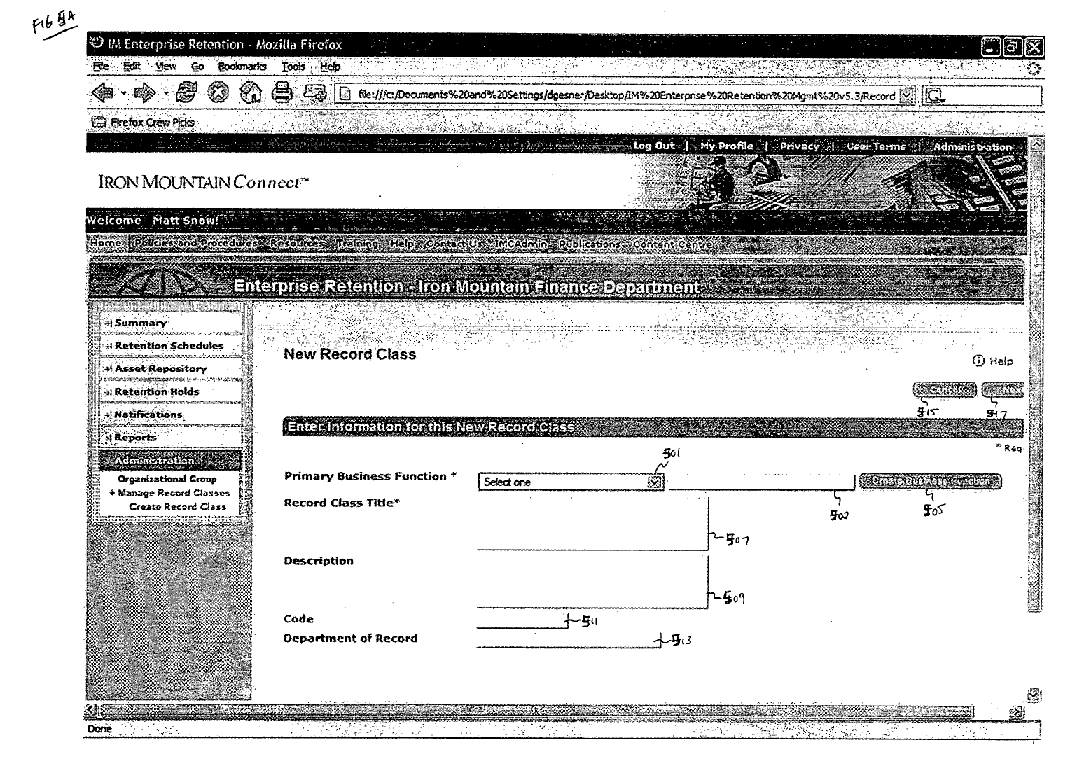

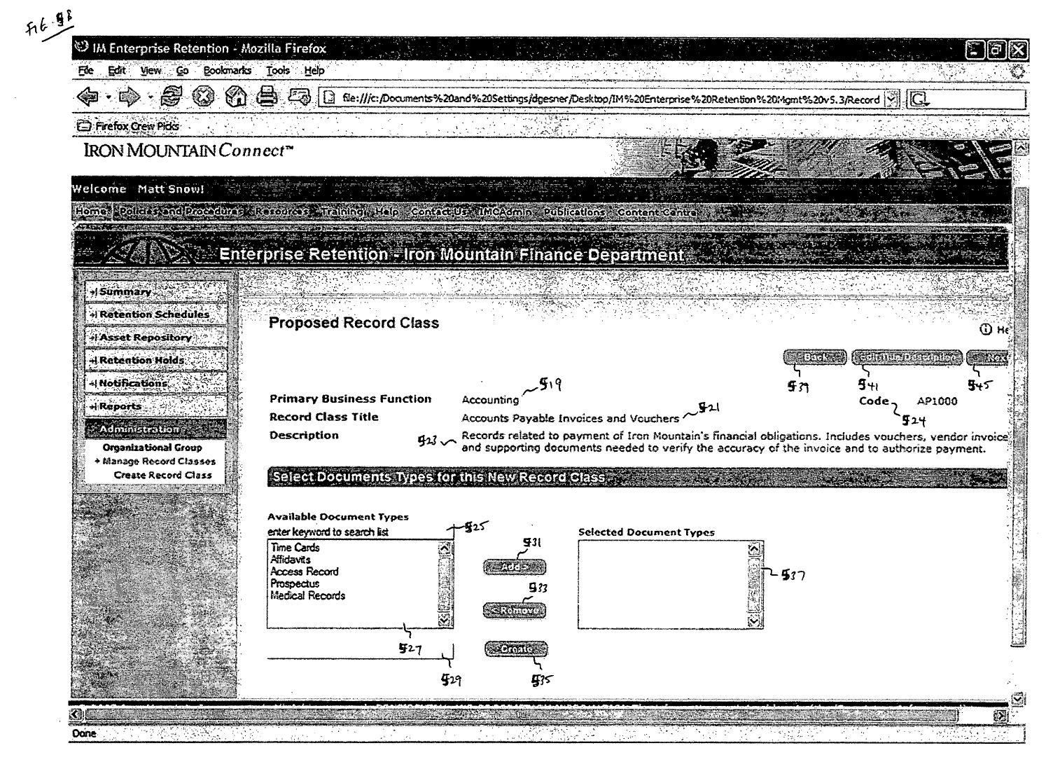

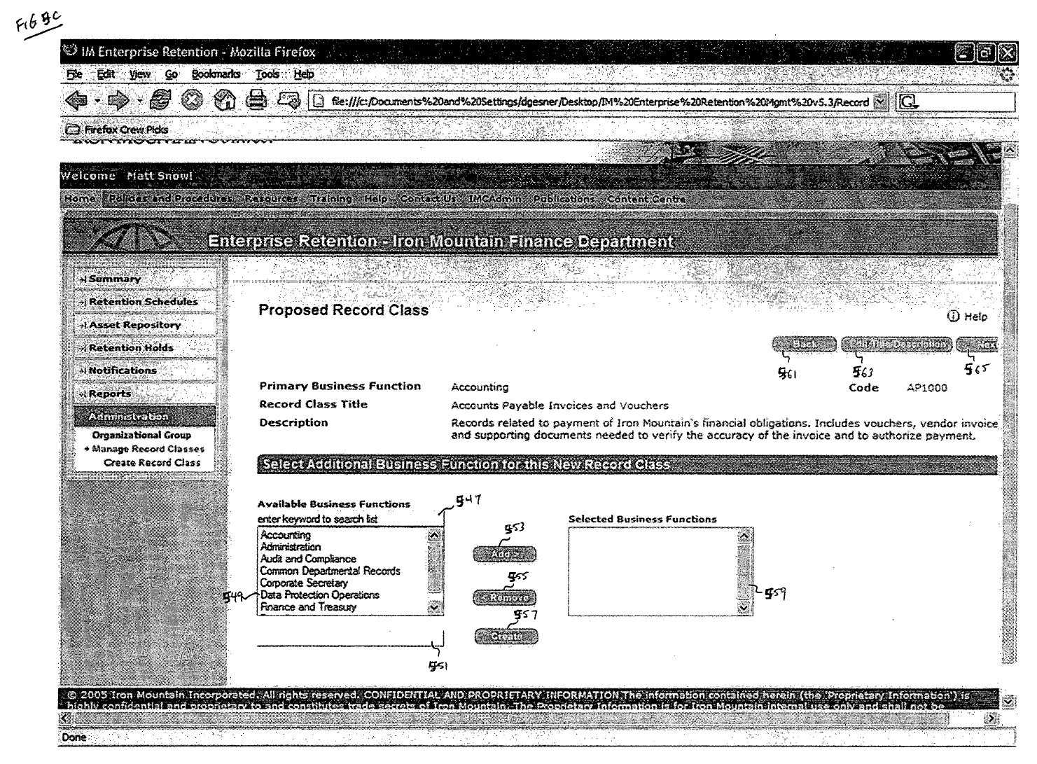

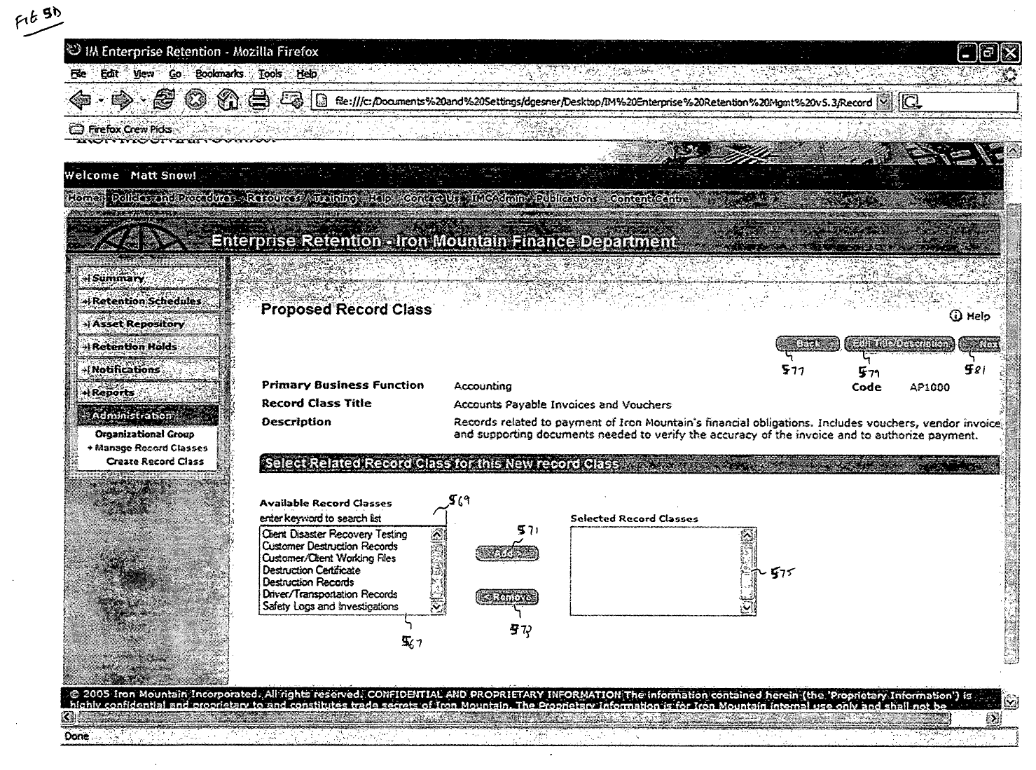

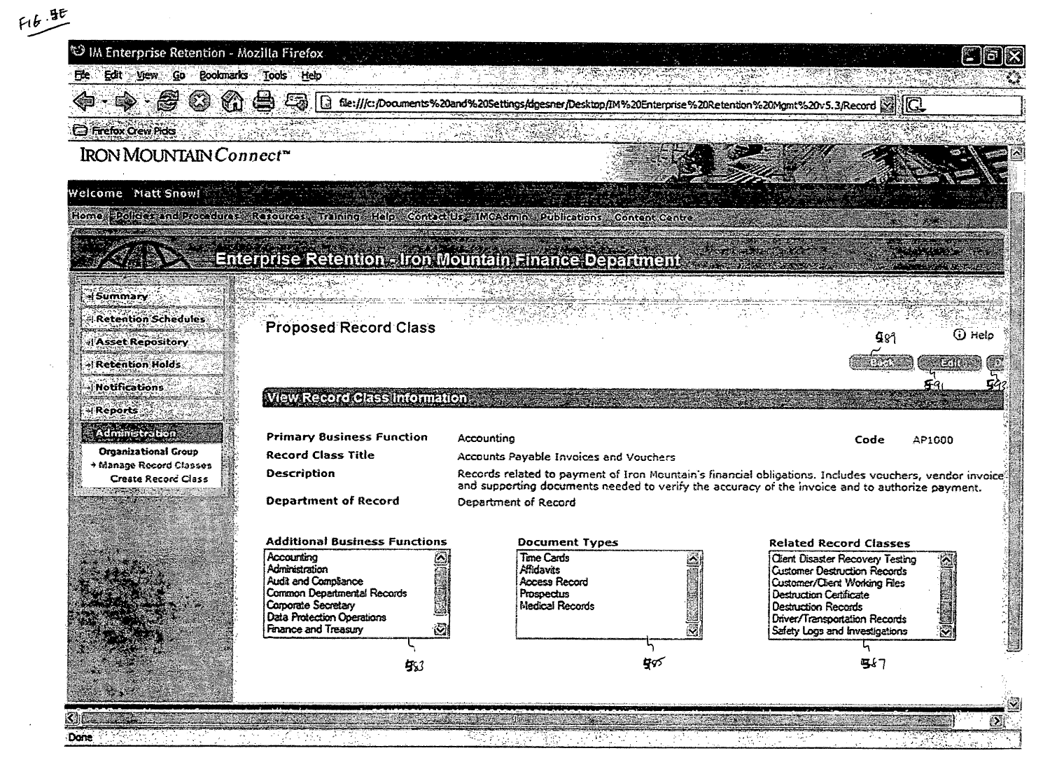

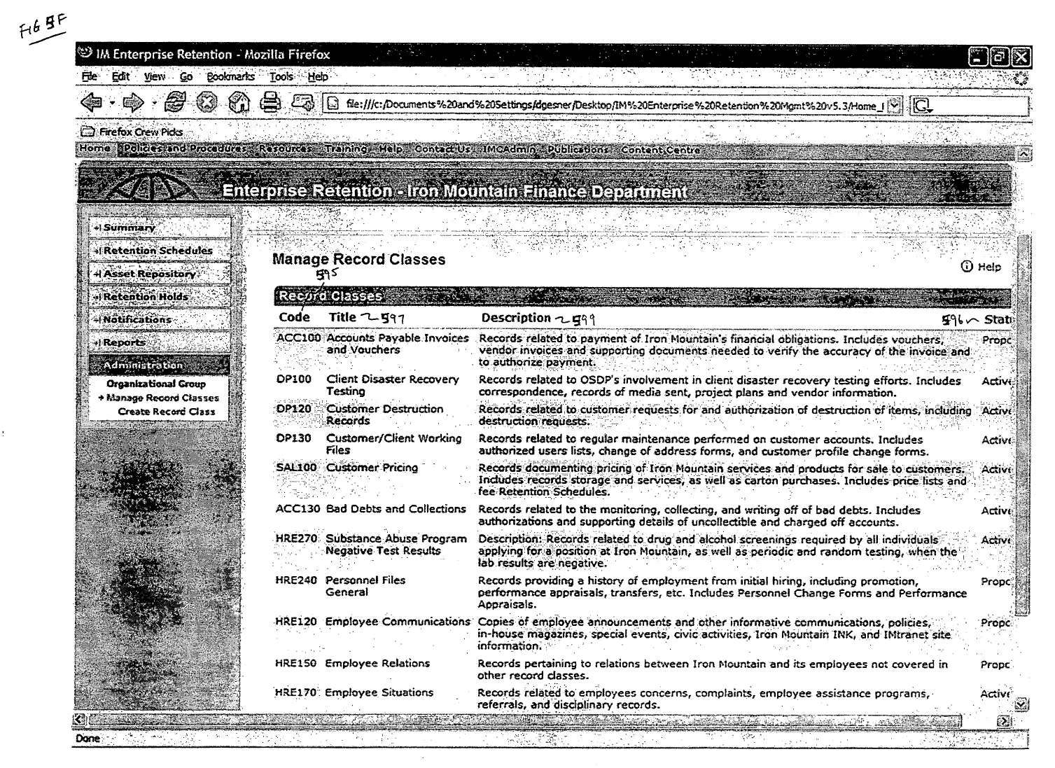

FIGS. 5A-5F depict screen interfaces which allow a user to specify information relating to a particular record class. The information provided by the user may be stored in, inter alia, record class table 205 shown in FIG. 2.

The screen interface shown in FIG. 5A allows a user to provide basic information on the considered record class. Using dropdown box 501, the user may select from a list of primary business functions for the record class. Alternatively, the user may provide typewritten input defining a primary business function in field 503, and click button 505 to cause this typewritten input to define a new business function (e.g., by storing the input in record class table 205). In field 507, the user may provide a title for the record class, and in field 509 the user may specify a description for the record class. In fields 511 and 513, the user may specify a code and a department of record for the record class, respectively. Upon providing this information, the user may click button 515 to cancel the creation of the record class, or click button 517 to proceed to the screen interface shown in FIG. 5B.

The screen interface shown in FIG. 5B allows the user to specify one or more document types included in the record class. In this respect, the screen interface of FIG. 5B displays the primary business function, title, description and code for the record class (e.g., defined using the screen interface of FIG. 5A).

In some embodiments, the primary business function may limit the document types which are presented to the user for selection. In the embodiment shown, the selection of a primary business function of “accounting” (shown in field 519) drives the presentation of a list of available document types in box 527. The user may select one or more of the entries shown in box 527 and then click on button 531 to add the selected document types to box 537, thereby creating a relationship between the newly established record class and the selected document types. If the user is unable to find the document types she wishes to select, she may provide typewritten input in box 525 to initiate a search of the list of available documents types in box 527. In addition, the user may provide typewritten input in box 529, and then click button 535 to create a new available document type which, in some embodiments, will cause the new available document type to be presented in box 527. The user may then select the newly created available document type and click button 531 to add it to the list of selected document types shown in box 537. If an available document type is erroneously selected and shown in box 537, the user may select it and click button 533 to remove the document type from the list of selected document types shown in box 537. In some embodiments, clicking button 533 will cause the document type to no longer be displayed in box 537, but rather to be displayed in box 527.

By clicking on box 539, the user may revert to the screen interface shown in FIG. 5A, and by clicking on box 545, the user may store the input data and proceed to the screen interface shown in FIG. 5C.

The screen interface shown in FIG. 5C allows the user to specify one or more business functions for the record class. Specifically, the user may select from the available business functions presented in box 549, and click button 553 to add the selected functions to a list displayed in box 559. If the user is unable to locate the business function in the list shown in box 549, the user may provide typewritten input in box 547 to search for a particular business function in the list. Alternatively, the user may provide typewritten input to box 551 and click button 557 to create a new business function, which in some embodiments will cause the new business function to be displayed in the list shown in box 549. If a business function is erroneously selected and displayed in box 559, the user may select that business function and click button 555 to remove that business function from box 559. In some embodiments, doing so causes the business function to be displayed once again in box 549.

Upon defining the business function for the record class, the user may click button 561 to revert to the screen interface shown in FIG. 5B, or click button 565 to store the input data and proceed to the screen interface shown in FIG. 5D.

The screen interface shown in FIG. 5D allows the user to select one or more record classes that are related to the record class that the user is defining. The user may select from the list of record classes shown in box 567 and click button 571 to add the selected record classes to a list shown in box 575. If the user is unable to locate a particular record class in the list shown in box 567, she may provide typewritten input into box 569 to search the list shown in box 567. If a particular record class is erroneously added to the list shown in box 575, the user may select the erroneously added classes and click button 573 to remove the selected classes from the list shown in box 575. In some embodiments, doing so causes the removed record classes to be immediately displayed in the list shown in box 567.

Upon selecting the related record classes, the user may click button 577 to revert to the screen interface shown in FIG. 5C, or click button 581 to store the input data and proceed to the screen interface shown in FIG. 5E.

The screen interface shown in FIG. 5E allows the user to view the record class information provided using the screen interface of FIGS. 5B-5E in summary form. Specifically, the user may view the business functions selected for the record class using the screen interface of FIG. 5C in box 583, the document types specified using the screen interface of FIG. 5B in box 585, and the record classes specified using the screen interface of FIG. 5D in box 587. If the user wishes to edit any of the information shown in boxes 583, 585 or 587, the user may click button 591, which in some embodiments causes the display to revert to the screen interface shown in FIG. 5B. By clicking button 589, the user may revert to the screen interface shown in FIG. 5D, and by clicking button 593, the user may store the input data and proceed to the screen interface shown in FIG. 5F.

The screen interface of FIG. 5F allows the user to view information on all record classes identified to the system. The information is displayed in columns 595 (“Code”), 597 (“Title”), 599 (“Description”) and 596 (“Status”).

User interface 120 may provide one or more screen interfaces that enable a user to define a retention schedule for a record class. In general, a user is given the capability to create one or more record classes for each information store (e.g., enterprise application 140) in the system registry, and define a retention period for each class.

A retention period may be defined in any suitable fashion. In some embodiments, the retention period (which may be may be expressed in days, months, years or any other suitable period) for records in a particular record class is defined to run from a “base date.” A base date may be any suitable point in time, such as a date a record was created, an “event date” (e.g., for a life insurance policy, a close date of a policy), a date a record was first stored, any other date, or a combination thereof.

A retention period may be based on a hierarchy of base dates. For example, a retention period may be based on a record creation date if available, and if not then on a storage date if available, and if not then on an event date. A retention period may also be permanent, indefinite or undefined. Any suitable retention period may be employed, as the invention is not limited in this respect.

In some embodiments, the system provides functionality which allows a user to specify a retention schedule, so that the retention of information assets in one or more record classes may be managed consistently. Specifically, in some embodiments, the system provides functionality enabling a user to define a retention schedule “from scratch” or using a template. In some embodiments, a template may be defined at least in part by the organizational group responsible for the considered assets, and that group's place in the overall organizational structure. For example, a parent organization group may define retention policies which are applied (i.e., inherited) by each subsidiary or child of the parent group. Inheritance functionality is described in further detail below with reference to FIG. 6. Screen interfaces enabling a user to define a retention schedule are described with reference to FIGS. 7A-7K.

FIG. 6 is a logical representation of an organization which includes a parent (P) organization 605 and three child organizations (C1, C2, C3) 610, 615, 620. One child organization group (C3) 620 employs three information asset stores 150A, 150B and 150C. Although not shown in FIG. 6, each of parent organization 605 and child organizations 610 and 615 also may employ one or more information asset stores. In addition, although not shown in FIG. 6, each child organization may itself have one or more child organizations (i.e. grandchild organizations with respect to parent organization 605). An organization may have any suitable number of levels and employ any suitable number of information stores.

In accordance with some embodiments of the invention, retention policy implemented at the level of the parent organization 605 may be inherited by each child organization so that retention policy may be applied consistently across the organization. For example, a retention schedule defined for a particular record class at the level of the parent organization 605 may be inherited by each child organization 610-620 and applied to assets in each information store 150.

In some embodiments, retention policy defined at one level of the organization may serve as a template for all subordinate levels, but may also be modified to suit the particular needs of an organizational group at a subordinate level. For example, a retention schedule defined at the level of parent organization 605 may specify that assets in a particular record class are held for seven years from the date of creation, and this policy may serve as a template for assets in that class maintained by child organizations 610, 615 and 620 in any information store 150. However, child organization 620 may desire to modify the template policy so as to hold records in the class for eight years. For example, a legal requirement may apply to assets maintained by child organization 620 which does not apply to assets maintained by parent organization, such as when the child organization 620 maintains assets which are subject to the laws of a different geopolitical entity than those maintained by the parent organization. This is described in further detail below in the “International Retention Management” section.

Application of a different retention policy at a subordinate level than at a parent level may be accomplished in any suitable fashion. In one example, the record class of assets maintained by the child organization may be changed, such that the new retention policy may be applied to the new record class. In another example, retention policy may be applied at the level of the organization and record class. The invention is not limited to any particular implementation.

In some embodiments, levels of an organization are represented in the organizational group table described above with reference to FIG. 3. As described above, this table may include an indication of each organization group, and any parent or child organization groups to which the organization is related.

The screen interfaces shown in FIG. 7A-7K enable a user to define a retention schedule. The screen interface of FIG. 7A allows the user the option of creating a retention schedule from scratch, or using an existing retention schedule as a template (e.g., defined via the inheritance rules described above with reference to FIG. 6). Specifically, by clicking link 701, the user may create a new retention schedule, and by clicking link 703 the user may copy an existing retention schedule. The process by means of which a user creates a new retention schedule is described below with reference to FIGS. 7B-7H, and the process by means of which a user may copy an existing retention schedule is described below with reference to FIGS. 7I-7K.

By clicking link 701, the user proceeds to the screen interface of FIG. 7B, which allows the user to specify basic information for the retention schedule. The user may specify a title for the retention schedule by providing input to box 705, and a description by providing input in box 707. By clicking button 709, the user may return to the screen interface shown in FIG. 7A, and by clicking button 711, the user may store the input data and proceed to the next screen interface shown in FIG. 7C.

The screen interface shown in FIG. 7C allows the user to create or select record classes to be managed according to the retention schedule. By clicking button 713, the user is provided with a facility to create a new record class (e.g., one which is similar to the screen interface shown in FIG. 7A), and by clicking button 715, the user may select from a list of record classes maintained in repository 129. In some embodiments, by clicking button 715 the user proceeds to the screen interface shown in FIG. 7D. Using this screen interface, the user may select from a list of record classes (denoted on the screen interface of FIG. 7D with buttons 717, 719 and 721). Upon selecting any or all of the listed record classes, the user may click button 723 to store the input data and proceed to the screen interface shown in FIG. 7E.

The screen interface of FIG. 7E allows the user to define an effective date at which the retention schedule will take effect. By providing input to box 725, the user may define this effective date. In some embodiments, the effective date enables a retention schedule to be imposed at a future date. The system may, for example, automatically impose the retention schedule when the effective date of implementation arrives. For example, the system may change a “proposed” retention schedule to an “active” one when the effective date of implementation arrives. Alternatively, the system may prompt the author of the retention schedule to implement it when the effective date arrives, or may implement the schedule in any other suitable fashion.

By clicking button 727, the user may revert to the screen interface shown in FIG. 7D, and by clicking button 729 the user may store the input data and proceed to the screen interface shown in FIG. 7F.

The screen interface of FIG. 7F allows the user to specify a retention period for each selected record class. In this respect, record class title 731 indicates that, when presented with the screen interface of FIG. 7D, the user had selected the record class having a title of “Accounts Receivable Cash Receipts And Invoices Customer Billing Support Records” by clicking button 717. The user may select a type of retention period for the considered record class by selecting from a list of types shown in dropdown box 733. Further, the user may specify an event from which the retention period will run by selecting from a list presented by dropdown box 735. Using the boxes and/or buttons provided in screen portions 739, 741, 743 and 745, the user may specify a period, defined in terms of years, months or days, for the official retention period, the operational requirement period, the legal requirement period and/or the legal consideration period. After specifying any or all of these periods, the user may click button 749 to store the input data and proceed to the screen interface of FIG. 7G.

Using the screen interface of FIG. 7G, the user may add one or more record classes to the retention schedule. Specifically, by clicking on any or all of checkboxes 751, the user may add one or more record classes to the retention schedule, such that the information assets in the chosen record classes will be managed as defined by the retention schedule. Upon selecting one or more additional record classes, the user may click on button 753 such that the user reverts to the screen interface of FIG. 7F to set the retention schedule for each chosen record class. By clicking button 755, the user may cause all of checkboxes 751 to be selected and by clicking button 757 the user may cause any of checkboxes 751 which had previously been selected to be un-selected. By clicking button 759, the user cancels the task of adding more record classes to the retention schedule, such that the user proceeds to the screen interface shown in FIG. 7H, which lists information in columns 761, 763, 765 and 767 relating to existing retention schedules.

As described above, the screen interface shown in FIG. 7I allows the user to use an existing retention schedule as a template for a new retention schedule. By clicking any of buttons 709, the user may select an existing retention schedule as a template. Information on existing retention schedules is shown in table form defined by columns 771 (“title”), 773 (“description”), 775 (“status”) and 777 (“effective date”). By clicking button 779, the user may cancel the process of copying an existing retention schedule, and by clicking button 781 the user may store the input data and proceed to the screen interface, shown in FIG. 7J.

The screen interface shown in FIG. 7J allows the user to edit various characteristics of a template retention schedule to create the new retention schedule. Specifically, the user may provide input to box 783 to modify the title of the retention schedule, to box 785 to provide a new description for the retention schedule, and/or to box 787 to provide a new effective date for the retention schedule. By selecting from a list provided in dropdown box 787, the user may specify a retention type for a particular record class, select a disposition action from a list shown in dropdown box 789, modify a duration by clicking link 791, and/or select an event from a list shown in dropdown box 793. Various embodiments of the invention may allow a user to modify any of the information displayed on the screen interface of FIG. 7J, and/or other information.

By clicking on button 797, the user may add one or more record classes to the retention schedule, by clicking 798 the user may activate the new retention schedule, and by clicking button 799 the user may revert to the screen interface shown in FIG. 7I.

The screen interface shown in FIG. 7K displays information relating to retention schedules created by users. Information on the retention schedules is presented in tabular form. Specifically, column 801 displays a title for each retention schedule, column 803 displays a description, column 805 displays a status, and column 807 displays an effective date. Upon clicking on button 809, the user is presented with a print-ready list of retention schedules (e.g., devoid of graphical formatting and resized for print form).

By clicking on button 811, the user may revert to the screen interface of FIG. 7A, such as to create a new retention schedule or use an existing retention schedule as a template. By clicking button 813, the user may edit any of the retention schedules selected from the table below using button 814, and by clicking button 815 the user may delete any retention schedule selected from the table below.

Some embodiments may enable a user to extend the retention period through the end of a fiscal period. For example, a retention period may be defined from a base date, but extended to the end of the fiscal period (e.g., year, quarter or other period). For example, an information asset created in July 2004 which is scheduled to be destroyed six years from the base date (i.e., July 2010) may instead be retained until the end of the fiscal year (e.g., December 2010, if the fiscal year is the calendar year).

Once a retention schedule is defined, it may be published to other members of the organization for review. As shown in FIG. 4, a retention schedule may have a status indicator of “active,” “proposed” (i.e., pending approval), and “obsolete” (i.e., no longer active).

In some embodiments, the system maintains an audit trail for each retention schedule. The audit trail may, for example, indicate the user who authorized a particular schedule to change from “proposed” to “active” and the date of authorization, and may indicate when a retention schedule is changed from “active” to “obsolete.” Further, the system may enable a user to view different versions of a retention schedule, so that, for example, a user may view the “proposed” version of a schedule before certain modifications were made. This information may be stored, for example, in audit record table 345 (FIG. 3).

Implementing a Retention Schedule

Because a retention schedule defines how long information assets in a record class should be retained, it impliedly defines when certain information assets in the record class should be destroyed or expunged. In some embodiments, the system issues instructions to expunge or destroy information assets at the end of the retention period for those assets. As described above, these instructions may be issued to an enterprise application directly, or to the administrator of an application.

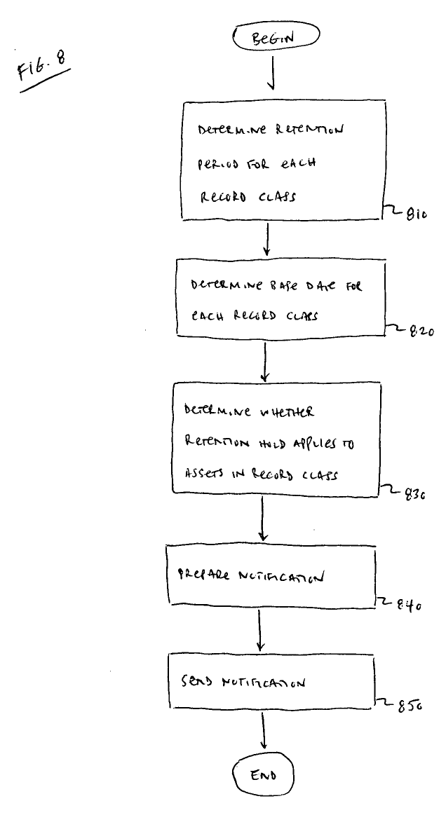

FIG. 8 depicts one example of a process which may be performed to implement a retention schedule. In some embodiments, process 800 is initiated upon the occurrence of an event, such as the occurrence of a date, a user action, and/or any other event. For example, the process 800 may be performed when a new retention schedule is defined for a particular record class (e.g., specifying that certain assets are not to be retained for as long as had been previously planned) or a date arrives on which a regularly scheduled process is to be executed to determine assets to be destroyed. The invention is not limited to any particular implementation, and any suitable event may cause process 800 to be initiated.

At the start of process 800, in act 810, a retention period is determined for each record class. In some embodiments, this is performed by examining data stored in the retention schedule table 315 (FIG. 3). Specifically, in some embodiments, the operational requirement and legal requirement fields may be examined for each record in the table (e.g., for each record class), and these requirements are reconciled to determine a retention period for a record class. In some embodiments, reconciliation includes determining the stricter of the operational and legal requirements and employing the stricter requirement as the retention period. For example, if the legal requirement for assets in a record class specifies that the assets should be kept for seven years, and the operational requirement specifies that they should be kept for eight years, the system may determine that assets in the record class should be kept for eight years to satisfy both requirements. However, the invention is not limited in this respect, as a retention period for assets in a record class may be determined in any suitable fashion.

The process then proceeds to act 820, wherein the base date is determined for assets in a record class. In some embodiments, this is performed by examining data stored in the record class table 305. Specifically, in some embodiments, the system examines the base date field for each record in the table (i.e. for each record class). For example, information in the base date field for a particular record class may indicate that the retention period should run from a date on which the records were created. A base date may be determined in any suitable fashion, as the invention is not limited to a particular implementation.

The process then proceeds to act 830, wherein it is determined whether a retention hold applies to assets in each record class. In some embodiments, this is performed by examining data in the retention hold table 335. Specifically, in some embodiments, the system checks to see whether a record exists in the retention hold table for assets in a record class (i.e. with an “assigned to class” field storing a record class). However, the existence of a retention hold for certain assets may be determined in any suitable manner.

The process then proceeds to act 840, wherein the system prepares one or more notifications. In some embodiments, this involves determining record classes for which a retention period and base date are specified (as determined in acts 810 and 820, respectively) and to which a retention hold does not apply (as determined in act 830). For example, it may be determined in acts 810-830 that assets in a particular record class are to be retained for seven years from the date of creation, and that a retention hold does not apply to the record class. In this example, a notification may be generated which includes instructions to destroy or expunge assets created more than seven years ago.

A notification may be generated in any suitable manner. In some embodiments, a notification may be dynamically generated (e.g., using content specific to a particular record class stored in the data structure of FIG. 3), pre-constructed (e.g., using predefined text), or include dynamically generated and pre-constructed portions. Continuing with the using the example given above, a notification with instructions to destroy assets created more than seven years ago may, for example, include a portion consisting of predefined text (e.g., a “canned” text portion providing basic information on the destruction of assets, which text portion may, for example, be stored in the data structure shown in FIG. 3) and a portion consisting of data elements extracted from one or more data structures (e.g., the data structure of FIG. 3, and/or other data structures) to more specifically describe the assets to be destroyed, the manner of destruction, and any other suitable information. For example, a dynamically generated portion of a notification may supplement a predefined or canned portion by providing information on the retention period (e.g., extracted from retention schedule table 315), base date (e.g., extracted from record class table 305), or any other information on the record class to which the notification relates. Information may be extracted from any suitable source and/or generated in any suitable manner, as the invention is not limited in this respect. In some embodiments, generation of a notification is performed by ERM facility 125 (FIG. 1), although this aspect of the invention may be implemented in any suitable manner.

In some embodiments, notifications may be consolidated so that only one notification is addressed to each recipient. For example, if a particular administrator is responsible for multiple record classes (e.g., more than one of information stores 150A-150D; FIG. 1), then a single notification may be prepared which includes instructions for each record class so that the administrator need not receive multiple notifications. However, the invention is not limited in this respect, as notifications may be prepared in any suitable fashion.

The process then proceeds to act 850, wherein the notification is sent. A notification may be sent via any of numerous communication vehicles, as the invention is not limited to a particular implementation. For example, a notification may be sent via email, be rendered as a screen interface when the recipient next logs on to the system, be sent as a text message to a cellular telephone or other communication device, be delivered via any other format, or a combination thereof.

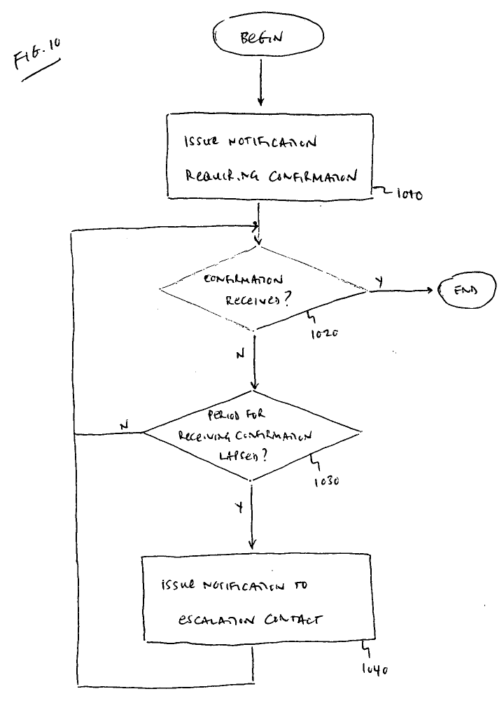

In some embodiments, a notification may require that the recipient confirm that instructions specified therein are carried out. For example, an email notification may include instructions for its recipient administrator on how to identify assets to be destroyed (e.g., run the “V6 destruction script” or other programmed commands), and request that the administrator confirm for audit purposes that the instructions have been carried out. For example, the notification may include text stating, “when destruction is complete, click on this link, indicate the quantity of records destroyed, the date and time destruction was performed, and the employee who performed the destruction.” A notification may indicate that an escalation contact will receive notification if an indication that the records have been destroyed is not received within a particular time period, as described in further detail below with reference to FIG. 10.

In some embodiments, the system may support not only notifications which require confirmation, but also informational notifications. For example, notifications may be sent to various recipients notifying them of an upcoming retention schedule change and not require the recipients to confirm that any action is taken in response.

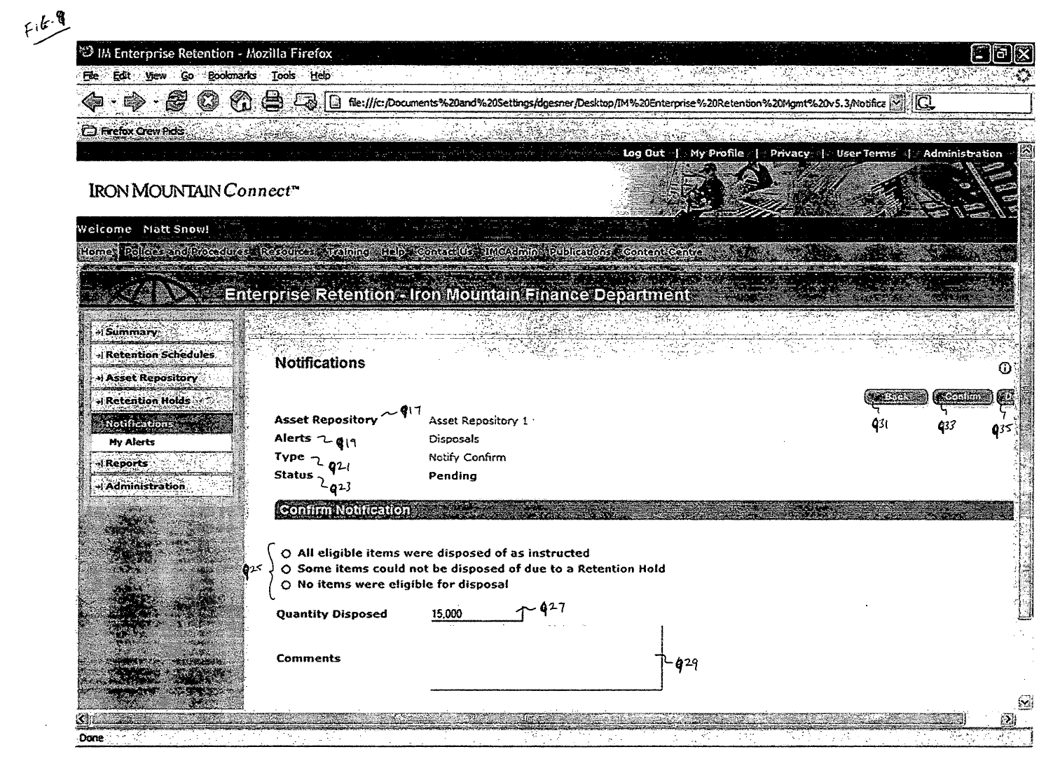

One example of a notification provided via screen interface is shown in FIG. 9. The notification includes instructions for destroying or expunging particular assets. Specifically, the instructions shown specify an asset repository 917 in which the information assets are maintained, a type of disposition action 919, type of notification 921, and status for the notification 923.

Upon receiving the notification, a recipient (e.g., administrator) may indicate the disposition action taken with respect to certain assets by selecting any of buttons 925. For example, the recipient may indicate that all eligible items were destroyed, some items could not be destroyed, or no items were eligible for disposal (e.g., none were older than the retention period as defined by the specified base date). The recipient may also provide input to box 927 to specify a quantity of assets destroyed, and provide comments in box 929. By clicking button 933, the administrator may confirm that the disposition actions have been completed. When this is done, information relating to the disposition action and/or information assets may be retained in repository 129 (e.g., in the simplified data structure shown in FIG. 3).

In some embodiments, the system maintains a log of disposition actions and/or other events occurring in relation to all registered information stores (e.g., in audit record table 345 shown in the data structure of FIG. 3). Specifically, as events occur the system may record audit data such as disposition action(s) taken, the user that performed the disposition action(s), and/or the date and time the disposition action(s) was (were) performed. The data may be accessed, for example, to generate reports on overdue disposition actions, disposition actions taken with respect to each enterprise application, total disposition actions taken, total overdue disposition actions, total disposition actions in progress, and/or any other desired indicia of retention policy implementation.

In some embodiments, escalation procedures may be implemented so that if instructions provided to a recipient are not executed within a predefined time period (e.g., specified in a notification, and maintained in the data structure of FIG. 3), an escalation contact (e.g., the recipient's superior or a compliance officer, which may also be defined in the data structure of FIG. 3) is notified. One example of a process 1000 which may be executed by the system to implement escalation procedures is shown in FIG. 10.

At the start of process 1000, in act 1010, a notification requiring confirmation is issued to the recipient. For example, instructions to dispose of certain information assets may be emailed to an administrator, and these instructions may require the administrator to confirm that the information assets are destroyed.

In act 1020, a determination is made as to whether a confirmation has been received that the instructions have been carried out. If it is determined that a confirmation has been received (e.g., an indication that a confirmation table is stored in audit record table 345, FIG. 3), process 1000 completes.

If it is determined that a confirmation has not been received, process 1000 proceeds to act 1030, wherein it is determined whether the predefined time period for receiving the confirmation has lapsed. If not, the process returns to act 1020, such that process 1000 continues in a loop until either a confirmation is received (and the condition of act 1020 is satisfied, such that process 1000 completes) or the predefined time period lapses.

When it is determined that the predefined time period has elapsed, process 1000 proceeds to act 1040, wherein a notification is sent to an escalation contact. For example, an email may be sent to the superior of the administrator to which instructions were sent in act 1010, a compliance officer, and/or any other suitable contact. The email may, for example, notify the escalation contact(s) that the administrator has not yet confirmed that disposal instructions have been carried out.

The process then returns to act 1020, such that process 1000 continues to loop through acts 1020 and 1030 until either a confirmation is received (such that the process ends) or the predefined time period lapses again. If the predefined time period lapses again, such that act 1040 is performed again, a notification may be sent to a further escalation contact. In this manner, if a confirmation is not received within the predefined time period after sending a first notification to a first escalation contact in act 1040, a second notification may be sent to a second escalation contact (e.g., the original escalation contact's superior), and so on, until a confirmation is received.

Of course, the invention is not limited to implementing escalation procedures in this manner, as any suitable technique(s) may be employed. Any suitable number of notifications may be sent to any suitable number of contacts in any suitable manner, as the invention is not limited in this respect.

Implementing a Retention Hold

In some embodiments, the system allows a user to identify certain information assets as being vital to the organization, such that even if the information asset is specified by a retention schedule, the record is not destroyed according to the retention schedule. For example, some embodiments of the system allow a user to subject certain information assets to a retention hold, such that all destruction activities pending or planned for those information assets may be postponed or cancelled. A retention hold may be implemented, for example, to support discovery requests, ongoing or planned litigation, or any other desired occurrence.

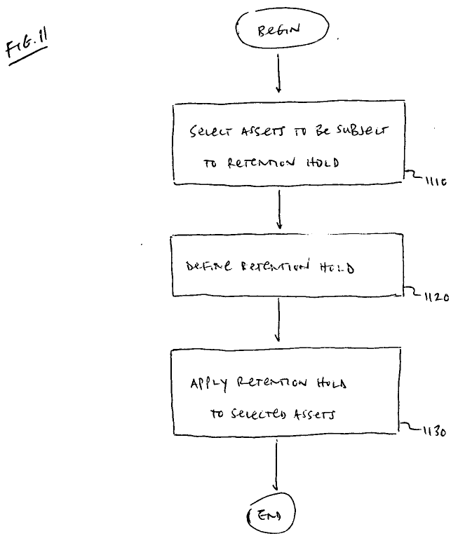

FIG. 11 depicts one example of a process 1100 for applying a retention hold to information assets in selected record classes or repositories. At the start of process 1100, information assets which are to be subject to the retention hold are selected in act 1110. This may be performed in any suitable fashion. In some embodiments, the system allows a user to apply a retention hold using rule-based, query-based, or tagging methods. For example, a rule-based hold causes assets in one or more record classes which satisfy certain criteria to be retained, such as record classes including records used by a certain organizational group, satisfying a certain date range (e.g., created and/or modified within a certain period after a given base date), having one or more associated keyword(s), comprising a certain asset type (e.g., email, image, box, file, etc.), and/or any other criteria. A query-based hold may, for example, cause assets in one or more record classes identified via query to be retained. For example, a user may execute a search for certain record classes, review the results and indicate that assets in selected classes should be subject to a hold. A tag-based hold may, for example, cause one or more record classes to be tagged, such as by modifying records and/or metadata (e.g., stored in the data structure of FIG. 3) representing the records.

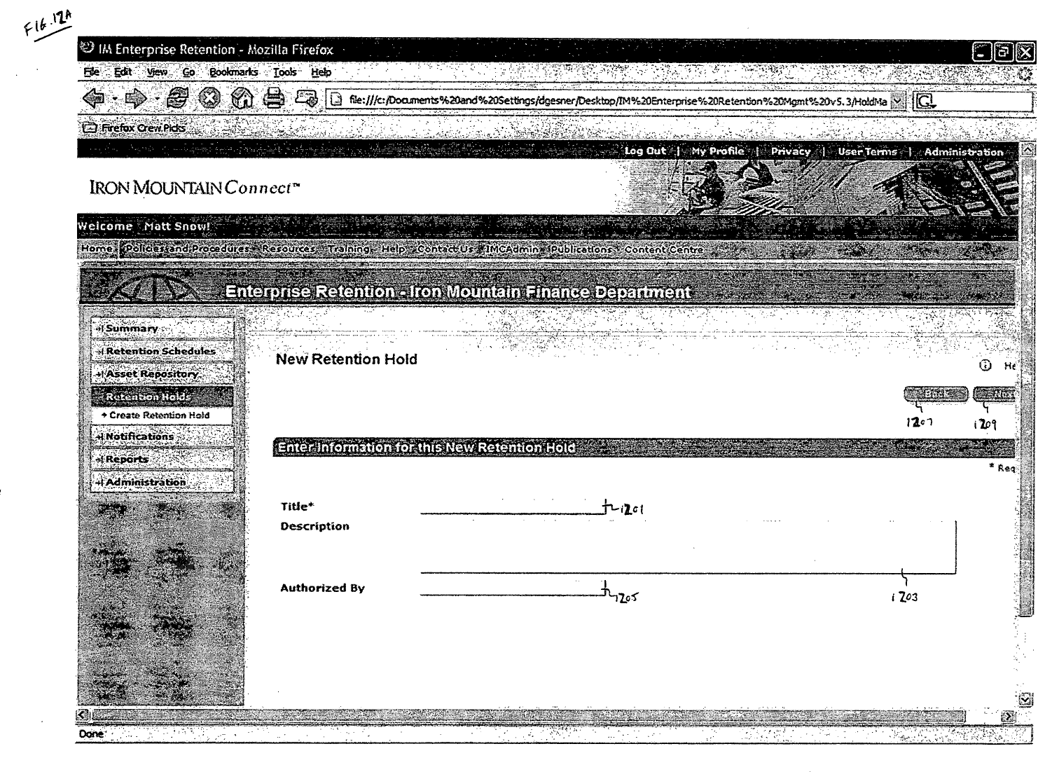

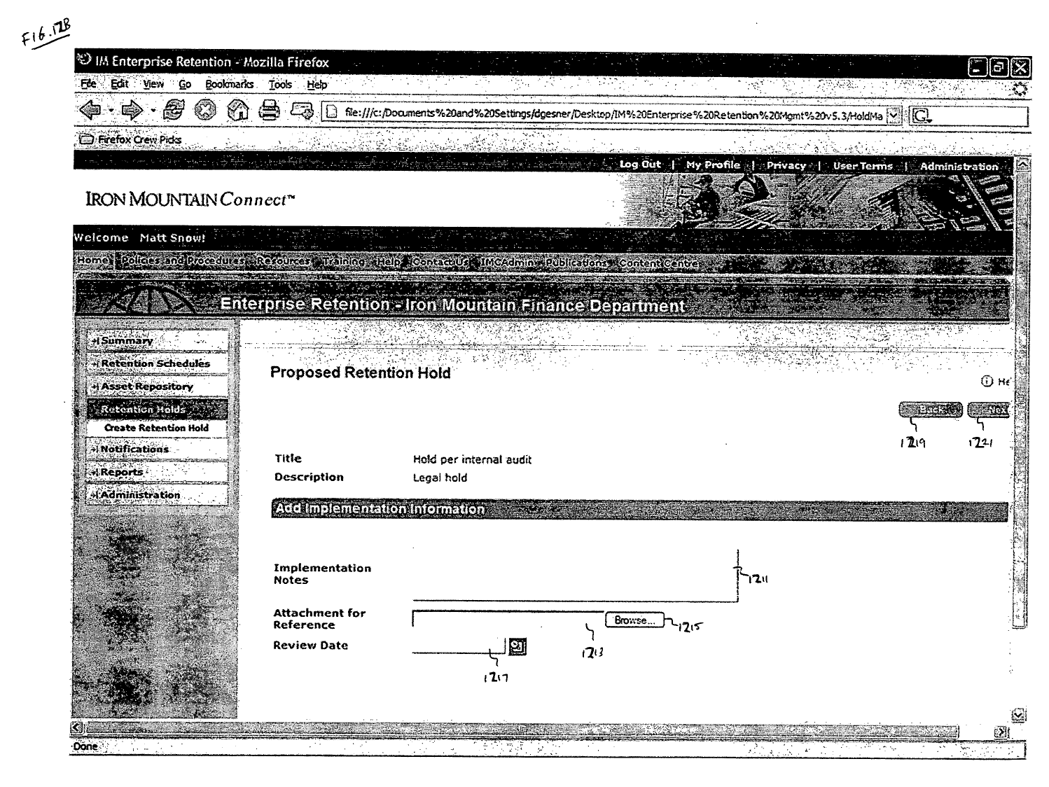

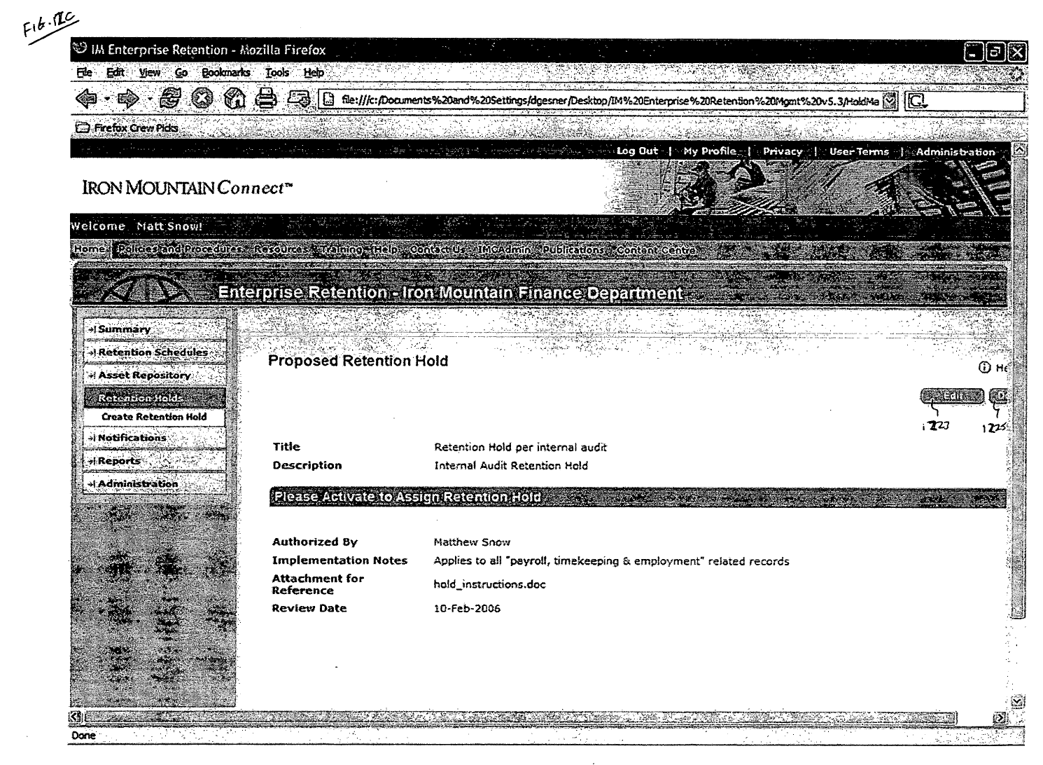

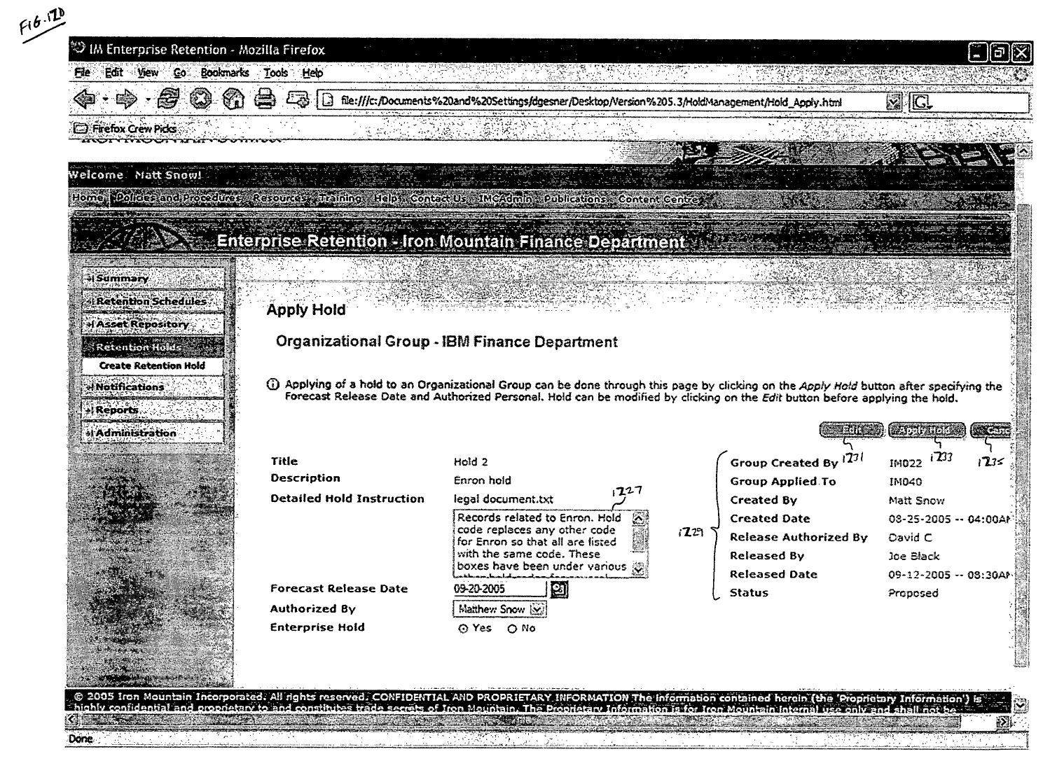

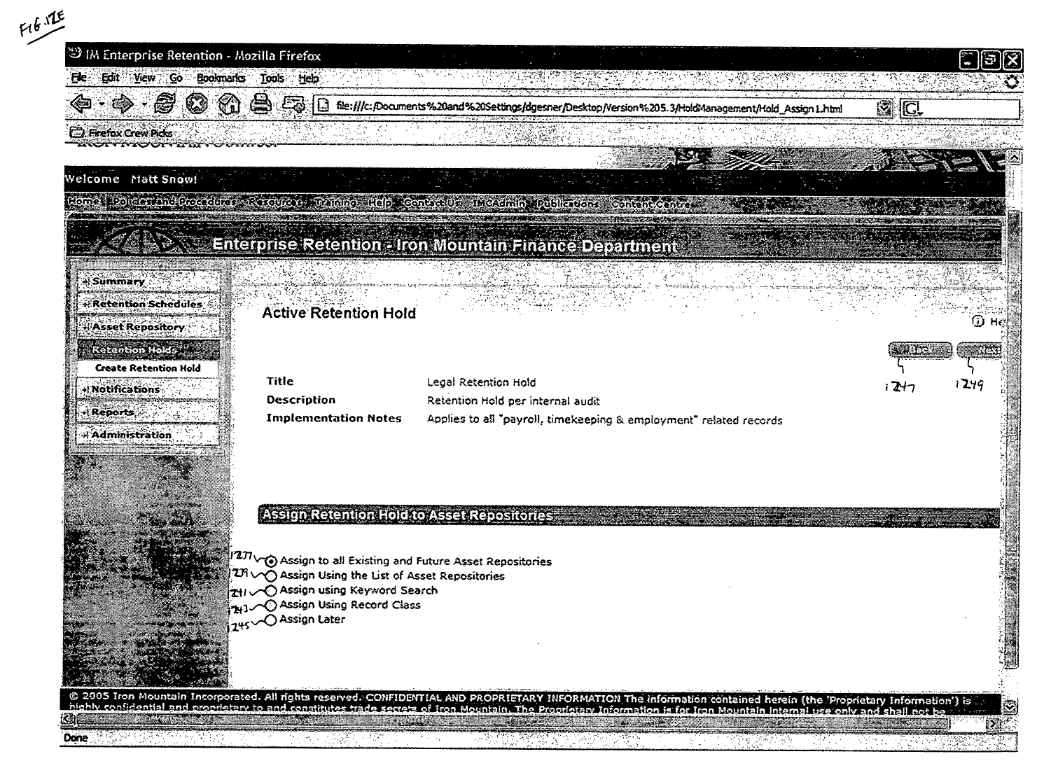

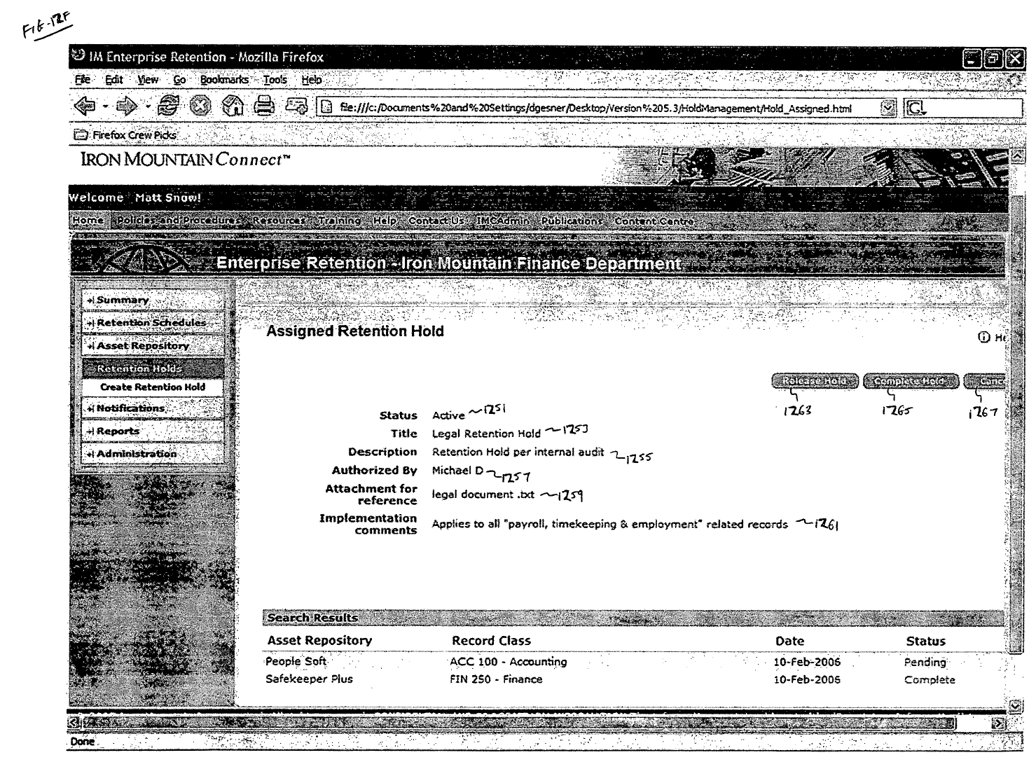

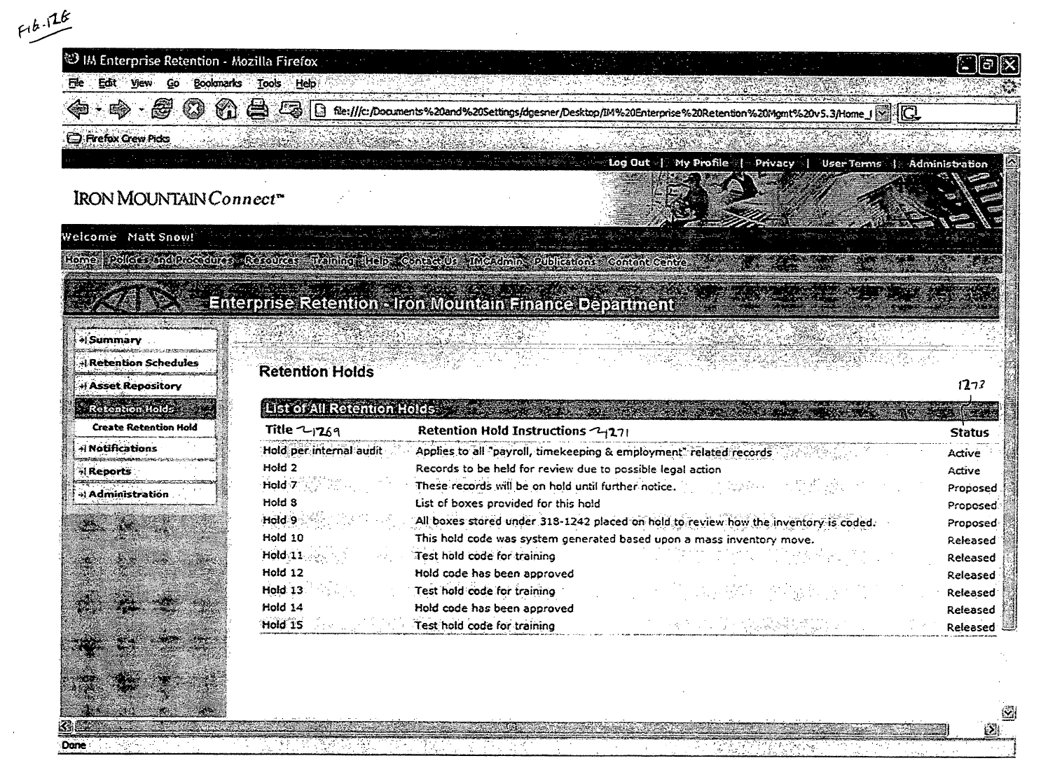

At the completion of act 1110, the process proceeds to act 1120, wherein the retention hold is defined. In some embodiments, the system may provide screen interfaces which allow a user to provide input defining the retention hold. Examples of screen interfaces which allow a user to define a retention hold are depicted in FIGS. 12A-12D.

In some embodiments, a user may define a proposed retention hold, and the proposed hold may be reviewed (e.g., by a business owner of the assets to which the retention hold applies) before the hold is implemented. The screen interfaces shown in FIGS. 12A-12D allow a user to define a proposed retention hold, which thereafter may be applied.

The screen interface of FIG. 12A allows the user to specify basic data relating to a retention hold. The user may specify a title for the hold in box 1201, a description in box 1203, and an authorizing party in box 1205. By clicking button 1209, the user may store the input data and proceed to the screen interface shown in FIG. 12B.

The screen interface depicted in FIG. 12B allows the user to supply data relating to the implementation of the hold. Using box 1211, the user may provide notes relating to the retention hold, including instructions relating to the information assets to which the retention hold applies. The user may upload a document containing implementation instructions by specifying the name and location of the document using box 1213 and/or browse button 1215, as is known in the art. The user may propose a date on which the instructions for the retention hold will be reviewed by using box 1217.

By clicking button 1219, the user may revert to the screen interface shown in FIG. 12A. By clicking button 1221, the user may store the input data and proceed to the screen interface of FIG. 12C.

The screen interface shown in FIG. 12C allows a user to view data relating to a proposed retention hold provided by the user using the screen interfaces of FIGS. 12A-12B. If the user desires to modify any of the information shown, he or she may click button 1223 to return to the screen interface of FIG. 12A. If not, the user may click button 1225 to store the input data and proceed to the screen interface of FIG. 12D.

The screen interface shown in FIG. 12D allows the user to provide information relating to the application of the retention hold. In box 1227, the user may provide detailed instructions relating to the application of the hold. Interface portion 1229 displays information relating to the hold and the user that created it. By clicking button 1231, the user may edit any or all of the information shown on the screen interface of FIG. 12D. By clicking button 1235, the user may cancel the retention hold.

After the user provides data relating to the proposed hold, process 1200 proceeds to act 1230, wherein the retention hold may be applied to the selected information assets. This may be performed in any suitable fashion. For example, in some embodiments the user may apply the retention hold by clicking button 1233 (FIG. 12D), whereupon the input data is stored, and process 1200 completes. Upon clicking button 1233, input data is stored, and the user proceeds to the screen interface shown in FIG. 12E.

The screen interface of FIG. 12E allows the user to provide additional data relating to the hold. Specifically, by clicking button 1237 the user may specify that the hold applies to all existing and future asset repositories, by clicking button 1239 the user may specify that the hold applies to a list of asset repositories, by clicking button 1241 the user may specify that the hold applies to asset repositories or record classes identified in a keyword search, by clicking button 1243 the user may specify that the hold applies to one or more record classes, and by clicking button 1245 the user may specify that the hold applies to record classes assigned later.

By clicking button 1247, the user may return to the screen interface of FIG. 12D (e.g., act 1120), and by clicking button 1249 the user may proceed to the screen interface of FIG. 12F.

The screen interface shown in FIG. 12F allows the user to review information relating to the applied retention hold. Specifically, field 1251 indicates that it has a status of “Active,” a title of “Legal Retention Hold,” a description of “Retention Hold Per Internal Audit,” was authorized by “Michael D,” references an attachment called “legal document.txt,” and provides implementation comments of “applies to all ‘Payroll, Timekeeping And Employment’ related records.” By clicking button 1263, the user may release (i.e., cancel) the hold, using button 1265 the user may complete (i.e., implement) the hold, and using button 1267 the user may cancel the hold.

The screen interface shown in FIG. 12G displays information relating to previously defined retention holds. Information is displayed in tabular form. A title for each hold is displayed in column 1269, instructions are displayed in column 1271, and a status is displayed in column 1273.

In some embodiments, the system maintains an audit trail for the creation and release of retention holds, such that information relating to retention holds may be reviewed by an administrator. Information relating to the creation and release of retention holds may be stored, for example, in audit record table 345 (FIG. 3).

Searches, Queries and Views

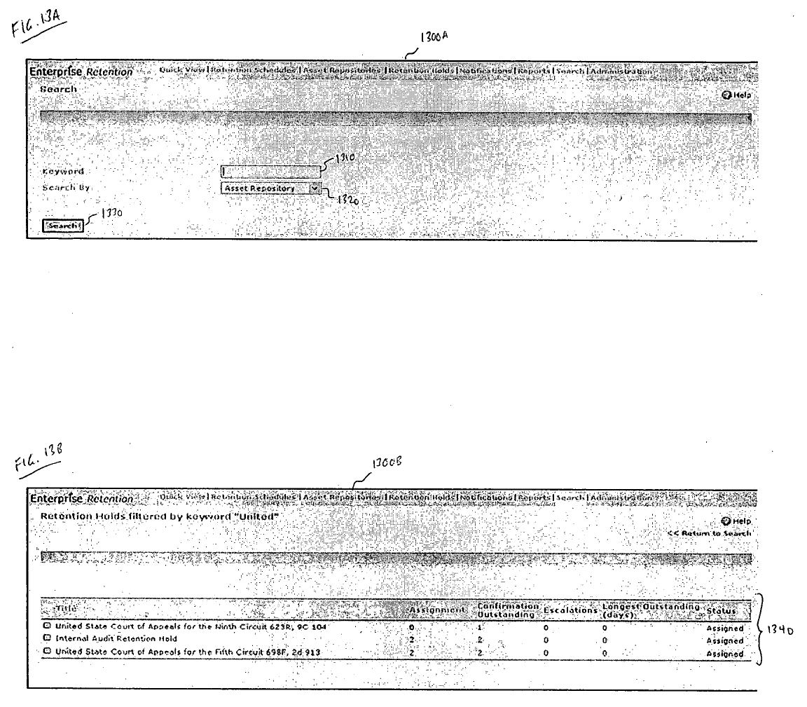

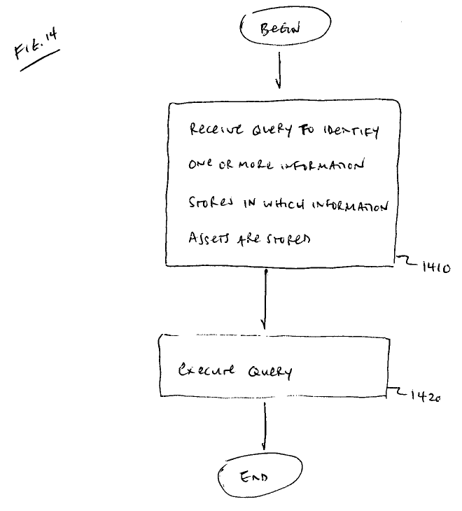

In some embodiments, user interface 120 (FIG. 1) provides one or more screen interfaces which enable a user to search for information assets, record classes, retention schedules, and/or retention holds that satisfy certain criteria. Examples of screen interfaces which allow a user to search for particular information assets, record classes, retention schedules, and/or retention holds, and to view the results of a search, are shown in FIGS. 13A-13B. One example of a process 1400 performed by the system to facilitate a user's search is shown in FIG. 14.

At the start of process 1400, a query is received (e.g., from a user) which provides search criteria. In some embodiments, search criteria may be supplied by a user via screen interface 1300A, shown in FIG. 13A. Screen interface 1300A includes text box 1310, drop-down box 1320 and button 1330. Text box 1310 allows a user to specify one or more keywords, each of which may include any alphanumeric text, for which the user would like to search from among one or more categories selected via drop-down box 1320. In some embodiments, the categories from which the user may select include information assets, record classes, retention schedules, and retention holds. Of course, the invention is not limited to these or any other categories, as any number and type of search categories may be provided. The invention is not limited to any particular implementation.

A user may, for example, specify search criteria by supplying typewritten input to text box 1310 and selecting a category shown in drop-down box 1320. For example, to search for retention holds defined to the system which include the word “United,” the user may type “United” in text box 1310 and select “retention hold” from among the categories displayed by drop-down box 1320. To initiate a search using this criteria, the user may click button 1330.

Process 1400 then proceeds to act 1420, wherein a search query is executed using the specified criteria. In some embodiments, the system executes the search against repository 129 (e.g., stored according to the data structure shown in FIG. 3). To execute the search described in the example given immediately above, the system may execute a query to determine all records in retention hold table 335 wherein the “Title” 337 includes the word “United.” Of course, a search need not be executed by performing a query on metadata, or on data stored in the manner depicted in FIG. 3. A search may be executed in any suitable manner, and those skilled in the art may envision numerous techniques for executing a search.

Screen interface 1330B, shown in FIG. 1300B, shows results generated for the search described in the above example. In particular, screen interface 1300B includes results 1340, each of which is a retention hold defined to the system which includes the keyword “United” in the title. Results may be displayed in any suitable manner, and include any suitable information.

At the completion of act 1420, process 1400 completes.

Using the techniques described above, a user may execute a “haystack” search to locate information assets, record classes, retention schedules, retention holds, and/or any other information satisfying certain criteria. A haystack search may be useful, for example, to find certain information assets in order to implement a retention hold on those assets. For example, a user may perform a haystack search to find all record classes having a title which includes the words “human resources,” so that a retention hold may be implemented for those record classes.

Of course, a haystack search may be performed for any suitable reason, which may or may not relate to implementing a retention hold. Embodiments of the invention are not limited to performing a search for any particular purpose, or in any particular manner.

In some embodiments, the system may impose views so that certain users may only view information relating to certain record classes and/or retention schedules. For example, a view may be employed to prevent an administrator from viewing any retention schedules except the schedule for the system he or she administers. Alternatively, users may only be given access to record classes and/or retention schedules relating to particular business units (e.g., a particular division, department or organization), media type (e.g., email, image or hard copy record classes), business function (e.g., so that the retention schedules a user is allowed to access is defined by the user's role in the organization), or any other suitable criteria.

International Retention Management

In some embodiments, the system provides an organization with the capability to manage the retention of information assets in a manner driven at least in part by the geographic location of the assets. For example, in some embodiments, information assets may be classified into different record classes based on the laws of the geopolitical entity (e.g., state, province, country, region, union and/or any other geopolitical entity) which apply to the information assets, so as to account for the different legal and/or regulatory requirements imposed by each geopolitical entity.

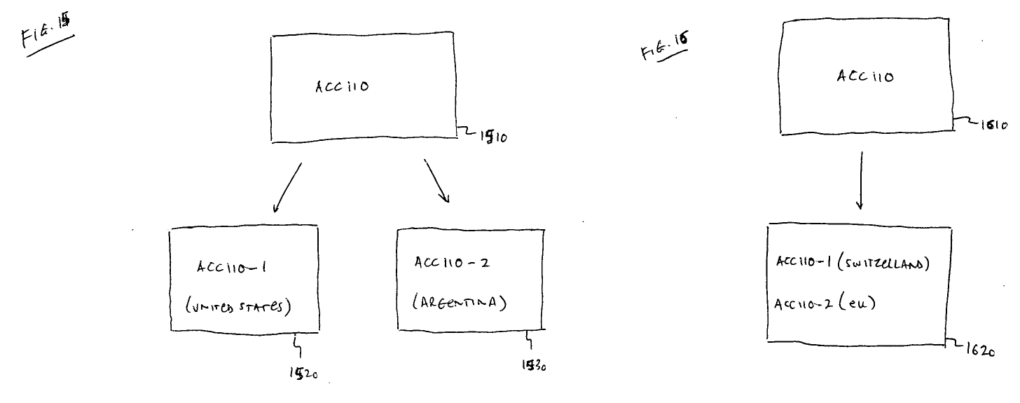

FIG. 15 illustrates an example. Block 1510 represents accounts payable records with a record class of “ACC110,” indicating that these records might normally be classified by an organization as belonging to a single record class, such as if the records were subject to the laws of a single geopolitical entity. Assume in this example, however, that a first portion of the records is subject to the laws of the United States and a second portion is subject to the laws of Argentina.

FIG. 15 illustrates that, in some embodiments, records represented by block 1510 may be split into two record classes, such that the first portion subject to the laws of the U.S. (represented by block 1520) is characterized by record class “ACC110-1” and the second portion subject to the laws of Argentina (represented by block 1530) is characterized by record class “ACC110-2.” Because the records are split into two record classes, different retention schedules may be applied to each portion, such that the legal requirements of the U.S. may be satisfied for the first portion represented by block 1520 via a first retention schedule, and the legal requirements of Argentina may be satisfied for the second portion represented by block 1530 via a second retention schedule. Hence, records subject to the legal requirements of different geopolitical entities may be managed differently, even though the information assets have the same general purpose and use to the organization.

It should be appreciated that the implementation described above with respect to FIG. 15 is merely exemplary, and that numerous techniques may be employed to apply different retention policies or schedules to a particular population of assets. For example, records need not be split into different record classes to implement different retention schedules for each portion. Rather, any attribute may specify that a particular retention policy applies to certain assets. In one example, a first portion may be assigned a record class of a first version, and a second portion may have the same record class but a different version. In another example, a portion may be tagged to indicate that a particular retention policy applies to that portion but not to others. Any of numerous techniques may be employed, as the invention is not limited in this respect.

In some embodiments, the system may manage the retention of assets subject to the laws of more than one geopolitical entity. FIG. 15 illustrates an example. Block 1510 represents accounts payable records with a record class of “ACC110,” indicating that these records might normally be classified by an organization as belonging to a single record class, such as if the records were subject to the laws of a single geopolitical entity. Assume in this example, however, that the records are subject to the laws of both Switzerland and the European Union (EU).

FIG. 16 illustrates that the records represented by block 1610 may be assigned two record classes, such that the records are characterized by the record class “ACC110-1” (for Switzerland) and by record class “ACC110-2” (for the EU) in block 1620. Because the records are assigned both record classes, retention policy defined in accordance with both sets of legal requirements may be applied to the records. As a result, the retention of the records may be managed by reconciling the Swiss and EU requirements. For example, if the laws of Switzerland allow the records to be destroyed seven years after creation and EU laws allow the records to be destroyed after nine years, then the system may reconcile these requirements to implement a retention schedule that applies the strictest requirement (i.e., EU laws) to retain the records for nine years.

It should be understood that the term “program” is used herein in a generic sense to refer to any type of computer code or set of instructions that can be employed to program a computer(s) or other processor(s) to implement various aspects of the present invention as discussed above. Additionally, it should be appreciated that in certain embodiments of the invention, one or more programs that, when executed, perform methods of the present invention, need not reside on a single computer or processor, but may be distributed amongst a number of different computers or processors to implement various aspects of the present invention.

In addition, it should be understood that the term “metadata” is used herein in a generic sense to refer to any type of structured or encoded data element(s) which describe(s) characteristics of information-bearing entities to aid in the identification, discovery, assessment, and/or management of the described entities (e.g., information assets). Additionally, it should be appreciated that in certain embodiments of the invention, metadata which aids in the identification, discovery, assessment, and/or management of information assets need not reside in a single computer memory, but may be distributed amongst a number of different computer memories to implement various aspects of the present invention.

Further, it should be understood that the terms “information store,” “data pool,” and “asset repository” are used herein to refer to any type of repository, collection, compilation, assemblage or system of information assets, which may be implemented or provided in electronic or non-electronic form. It should be appreciated that in certain embodiments of the invention, an information store or asset repository need not reside on a single computer memory or storage facility, but may be distributed amongst a number of different memories or storage facilities to implement various aspects of the invention.

When we refer herein to a “means” for performing a function, we do not intend to limit such an element to one or more processors implementing the recited function solely in the manner shown in the foregoing example(s), but also to include other interchangeable mechanisms for performing the same function, even if different hardware or software elements are employed.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for managing the retention of information assets stored in a plurality of information stores, at least one information store being in communication with a software application which stores information assets in electronic form, each information asset being classifiable into one of a plurality of record classes, the method comprising acts of:
(A) defining an abstraction which represents the information assets stored in the information stores, the abstraction including a representation of at least one record class in which information assets are categorized;
(B) defining a retention schedule which specifies a retention event for the information assets in at least one record class;
(C) implementing the retention schedule by communicating an instruction to perform a retention event with respect to the information assets in the at least one record class.

2. The method of claim 1, wherein the abstraction is embodied in metadata.

3. The method of claim 1, wherein at least one of the information stores includes information assets in hard copy form.

4. The method of claim 1, wherein the act (C) further comprises communicating an instruction to destroy or expunge the information assets in at least one record class.

5. The method of claim 4, wherein the instruction is communicated directly to at least one information store.

6. The method of claim 4, wherein the instruction is communicated to an administrator of at least one information store.

7. The method of claim 1, wherein the act (C) further comprises communicating an instruction to hold information assets in at least one record class so that said information assets are not destroyed or expunged.

8. The method of claim 1, further comprising an act of:
(D) performing the retention event by executing programmed instructions.

9. The method of claim 1, wherein the retention schedule specifies a retention event defined in relation to: a date an information asset is created, a date an information asset is first stored, and a date on which an event occurs.

10. The method of claim 1, wherein the at least one information store includes one information store subject to a law of a first geopolitical entity and another information store subject to a law of a second geopolitical entity.

11. At least one computer-readable medium having instructions encoded thereon which, when executed, perform a method for managing the retention of information assets stored in a plurality of information stores, at least one information store being in communication with a software application which stores information assets in electronic form, each information asset being classifiable into one of a plurality of record classes, the method comprising acts of:
(A) defining an abstraction which represents the information assets stored in the information stores, the abstraction including a representation of at least one record class in which information assets are categorized;
(B) defining a retention schedule which specifies a retention event for the information assets in at least one record class;
(C) implementing the retention schedule by communicating an instruction to perform a retention event with respect to the information assets in the at least one record class.

12. The at least one computer-readable medium of claim 11, wherein the abstraction is embodied in metadata.

13. The at least one computer-readable medium of claim 11, wherein at least one of the information stores includes information assets in hard copy form.

14. The at least one computer-readable medium of claim 11, wherein the act (C) further comprises communicating an instruction to destroy or expunge the information assets in at least one record class.

15. The at least one computer-readable medium of claim 14, wherein the instruction is communicated directly to at least one information store.

16. The at least one computer-readable medium of claim 14, wherein the instruction is communicated to an administrator of at least one information store.

17. The at least one computer-readable medium of claim 11, wherein the act (C) further comprises communicating an instruction to hold information assets in at least one record class so that said information assets are not destroyed or expunged.

18. The at least one computer-readable medium of claim 11, further comprising an act of:
(D) performing the retention event by executing programmed instructions.

19. The at least one computer-readable medium of claim 11, wherein the retention schedule specifies a retention event defined in relation to: a date an information asset is created, a date an information asset is first stored, and a date on which an event occurs.

20. The at least one computer-readable medium of claim 11, wherein the at least one information store includes one information store subject to a law of a first geopolitical entity and another information store subject to a law of a second geopolitical entity.

21. A system for managing the retention of information assets comprising:
a plurality of information stores for storing the information assets, each information asset being classifiable into one of a plurality of record classes;
at least one software application in communication with at least one of the information stores for storing information assets in electronic form;
an abstraction definition component operable to define an abstraction representing the information assets stored in the information stores, the abstraction including a representation of at least one record class in which information assets are categorized;
a retention schedule definition component operable to define a retention schedule specifying a retention event for the information assets in at least one record class;
a retention schedule implementation component operable to implement the retention schedule by communicating an instruction to perform a retention event with respect to the information assets in the at least one record class.

22. The system of claim 21, wherein the abstraction definition component is further operable to embody the abstraction in metadata.

23. The system of claim 21, wherein at least one of the information stores includes information assets in hard copy form.

24. The system of claim 21, wherein the retention schedule implementation component is further operable to communicate an instruction to destroy or expunge the information assets in at least one record class.

25. The system of claim 24, wherein the retention schedule implementation component is further operable to communicated the instruction directly to at least one information store.

26. The system of claim 24, wherein the retention schedule implementation component is further operable to communicate the instruction to an administrator of at least one information store.

27. The system of claim 21, wherein the retention schedule implementation component is further operable to communicate an instruction to hold information assets in at least one record class so that said information assets are not destroyed or expunged.

28. The system of claim 21, further comprising a retention event execution component operable to perform the retention event by executing programmed instructions.

29. The system of claim 21, wherein the retention schedule definition component further specifies a retention event in relation to: a date an information asset is created, a date an information asset is first stored, and a date on which an event occurs.

30. The system of claim 21, wherein the at least one information store includes one information store subject to a law of a first geopolitical entity and another information store subject to a law of a second geopolitical entity.

31. In a system in which a plurality of information assets are stored in a plurality of information stores, each information asset being classifiable into one of a plurality of record classes, each record class having at least one characteristic recorded in metadata, a method comprising an act of:
(A) executing a query on the metadata to determine at least one information store in which information assets classified in at least one record class are stored.

32. The method of claim 31, wherein the act (A) is performed to implement a policy relating to the retention of the information assets.

33. The method of claim 31, wherein the at least one characteristic comprises a characteristic from a group comprising: a business organization to which the information asset belongs, a date characterizing the information asset, a keyword, a document type, a business function, and a geopolitical entity in which the information asset is stored.

34. The method of claim 31, further comprising an act of:
(B) upon the completion of the act (A), causing an indication to be created specifying that the information assets should be retained.

35. The method of claim 34, wherein the information assets are stored in a first subset of the information store(s) in electronic form, and wherein the indication is stored in at least one of the metadata and the first subset of information store(s).

36. The method of claim 34, wherein the information assets are stored in a second subset of the information store(s) in hard copy form, and wherein the indication is stored in hard copy form in the second subset of information store(s).

37. At least one computer-readable medium having instructions encoded thereon which, when executed in a system in which a plurality of information assets are stored in a plurality of information stores, each information asset being classifiable into one of a plurality of record classes, each record class having at least one characteristic recorded in metadata, perform a method comprising an act of:
(A) executing a query on the metadata to determine at least one information store in which information assets classified in at least one record class are stored.

38. The at least one computer-readable medium of claim 37, wherein the act (A) is performed to implement a policy relating to the retention of the information assets.

39. The at least one computer-readable medium of claim 37, wherein the at least one characteristic comprises a characteristic from a group comprising: a business organization to which the information asset belongs, a date characterizing the information asset, a keyword, a document type, a business function, and a geopolitical entity in which the information asset is stored.

40. The at least one computer-readable medium of claim 37, further comprising instructions which, when executed, perform an act of:
(B) upon the completion of the act (A), causing an indication to be created specifying that the information assets should be retained.

41. The at least one computer-readable medium of claim 40, wherein the information assets are stored in a first subset of the information store(s) in electronic form, and wherein the indication is stored in at least one of the metadata and the first subset of information store(s).

42. A system for managing the retention of information assets comprising:
a plurality of information stores in which a plurality of information assets are stored, each information asset being classifiable into one of a plurality of record classes;
metadata operable to record at least one characteristic for each record class; and
a query component operable to execute a query on the metadata to determine at least one information store in which information assets classified in at least one record class are stored.

43. The system of claim 42, wherein the query component is further operable to execute a query to implement a policy relating to the retention of the information assets.

44. The system of claim 42, wherein the metadata records at least one characteristic from a group of characteristics comprising: a business organization to which the information asset belongs, a date characterizing the information asset, a keyword, a document type, a business function, and a geopolitical entity in which the information asset is stored.

45. The system of claim 42, further comprising:
an indication creation component operable to, upon the execution of a query by the query component, cause an indication to be created specifying that the information assets should be retained.

46. The system of claim 45, wherein the information stores store a first subset of the information assets in electronic form, and wherein the indication is stored in at least one of the metadata and the first subset of information store(s).

47. The method of claim 45, wherein the information stores store a second subset of the information assets in hard copy form, and wherein the indication is stored in hard copy form in the second subset of information store(s).
